(19) United States
(12) Patent Application Publication
(10) Pub. No.: US 2025/0282190 A1
(43) Pub. Date: Sep. 11, 2025

(54) QUICK CONNECT BALL COUPLER

(71) Applicant: Gen-Y Creations, LLC, Nappanee, IN (US)

(72) Inventor: Carl J. Borkholder, Nappanee, IN (US)

(73) Assignee: Gen-Y Creations, LLC, Nappanee, IN (US)

(21) Appl. No.: 19/215,736

(22) Filed: May 22, 2025

Related U.S. Application Data
(63) Continuation-in-part of application No. 18/766,933, filed on Jul. 9, 2024.
Application No. 18/766,933 is a continuation-in-part of application No. 18/318,863, filed on May 17, 2023.
Application No. 18/318,863 is a continuation-in-part of application No. 17/888,663, filed on Aug. 16, 2022.

(51) Int. Cl. B60D 1/06; B60D 1/28; B60D 1/48

(52) U.S. Cl. CPC B60D 1/065; B60D 1/28; B60D 1/488

(57) ABSTRACT

A self-latching ball coupler has a lever that rotates on an axis between a latched position and a released position. In the latched position, the coupler can receive and latch to a hitch ball that is moved into a ball pocket or retain the hitch ball that is located in the ball pocket. A spring is in biased contact with the lever that urges the lever towards the latched position when it is away from the released position. In the released position, the spring is in biased contact with a different portion of the lever to retain the lever in the released position. Once the lever is in the released position and the hitch ball is moved out of its ball pocket, the hitch ball contacts the lever, which moves it away from the released position and the spring urges the lever to the latched position.

### CROSS REFERENCE TO RELATED APPLICATIONS

This application is a Continuation-in-Part of U.S. application Ser. No. 18/766,933 filed Jul. 9, 2024, which is a Continuation-in-Part of U.S. application Ser. No. 18/318,863 filed May 17, 2023, which is a Continuation-in-Part of U.S. application Ser. No. 17/888,663, filed Aug. 16, 2022, the disclosures of which are hereby incorporated by reference.

### BACKGROUND OF THE INVENTION

The present disclosure relates to couplers between a towing vehicle and a trailer. The most common coupler involves a ball and socket, which provides a secure connection that still allows freedom of movement between the vehicle and trailer. Ball and socket couplers have been around for many years and have proven to be a reliable and flexible connection, but can be difficult to align, mate, and secure. Others have attempted to design a simple coupler, but these can still require significant hand strength to operate, have dangerous pinch points, or be difficult to release. Other devices, such as the device shown in U.S. Pat. No. 6,113,125, allow for easy coupling of a hitch but this device must be held in a release position to release the hitch ball. There is no automatic retention in the release position or automatic reset of the coupler for receiving the hitch ball once removed. For these reasons, an improved ball coupler is needed.

### SUMMARY OF THE INVENTION

The present disclosure describes a self-latching ball coupler for coupling and releasing a hitch ball having a diameter. The ball coupler has a housing with a fixed ball pocket complementary to the diameter of the hitch ball. The fixed ball pocket has an opening and the housing has a slot adjoining and extending into the fixed ball pocket. The housing has a lever shroud portion flanking the slot that extends beyond the opening in a direction opposite the fixed ball pocket. The coupler has a lever located in the slot and that is rotatable about a shaft axis between a latched position and a released position. The lever has a concave ball engagement surface spaced from the shaft axis by a first distance, and the concave ball engagement surface extends to a concave ball clearance cove surface that is spaced from the shaft axis by a second distance. The concave ball clearance cove surface terminates at a reset portion. In the latched position, the concave ball engagement surface faces the fixed ball pocket. In the released position, the concave ball clearance cove surface faces the fixed ball pocket. The coupler includes a release handle fixed with respect to the lever and is locked in rotation therewith. The coupler includes a spring in biased contact with the lever. When the lever is in the released position, only the spring retains the lever in the released position. When the lever is moved away from the released position, the spring urges the lever towards the latched position. The hitch ball is removable from the fixed ball pocket when the lever is in the released position. When the lever is in the released position, the reset portion extends into the opening to narrow it to be smaller than the diameter of the hitch ball, and when the hitch ball is removed from the fixed ball pocket, the hitch ball contacts the reset portion and moves the lever away from its released position.

In addition, the spring has a fixed portion in biased contact with the housing and a moving portion connected to the fixed portion. The moving portion has a follower portion and the lever has a cam surface. The follower portion is spaced from the cam surface when the lever is in its released position. The follower portion is in biased contact with the cam surface when the lever is moved away from its released position. When the lever is in the latched position and the hitch ball is moved into the fixed ball pocket, the lever remains in biased contact with the hitch ball and the follower portion remains in contact with the cam surface. The spring is formed from a strip of flat material and the follower portion is obliquely angled with respect to the moving portion.

### BRIEF DESCRIPTION OF THE DRAWINGS

FIG. 1 is a top isometric view of a coupler in use connecting a trailer and towing vehicle;

FIG. 2 is a top isometric view of the coupler in FIG. 1;

FIG. 3 is a bottom isometric view of the coupler in FIG. 2;

FIG. 4 is an exploded isometric view of the coupler in FIG. 2;

FIG. 5 is an exploded isometric view of the housing alignment to the gooseneck tube and ball pocket;

FIG. 6 is a side section view 6-6 of the coupler in FIG. 2 in the captured position;

FIG. 7 is a side section view 6-6 of the coupler in FIG. 2 in the released position;

FIG. 8 is a top section view 8-8 of the coupler in FIG. 2 in the captured position;

FIG. 9 is a top isometric view showing a bumper-mounted embodiment of the hitch coupler in use connecting a trailer and towing vehicle;

FIG. 10 is a top isometric view of the coupler in FIG. 9;

FIG. 11 is a top isometric view of a manually-operated embodiment of the coupler shown in FIG. 1;

FIG. 12 is a bottom isometric view of the coupler shown in FIG. 11;

FIG. 13 is a side section view 13-13 of the coupler in FIG. 11 in the captured position;

FIG. 14 is an exploded isometric view of the coupler in FIG. 11;

FIG. 15 is a top section view 15-15 of the coupler in FIG. 11;

FIG. 16 is a top section view 15-15 of the coupler in FIG. 11 after being moved to the unlocked position;

FIG. 17 is a front isometric view of a self-resetting embodiment of the coupler;

FIG. 18 is an exploded view of the coupler in FIG. 17;

FIG. 19 is a rear view of the coupler in FIG. 18;

FIG. 20 is an exploded view of the locking mechanism of the coupler in FIGS. 17 and 18

FIG. 21A is an isometric view of the locking mechanism components in FIG. 20 in the locked/captured position;

FIG. 21B is a section view 17-17 of the coupler in the locked/captured position;

FIG. 22A is an isometric view of the locking mechanism components in FIG. 20 in the reset position;

FIG. 22B is a section view 17-17 of the coupler in the reset position;

FIG. 23A is an isometric view of the locking mechanism components in FIG. 20 in the release position;

FIG. 23B is a section view 17-17 of the coupler in the release position;

FIG. 24 is an isometric view of an alternate gooseneck embodiment of the self-resetting coupler;

FIG. 25 is a section view 25-25 of the gooseneck coupler in FIG. 24;

FIG. 26 is a top front isometric view of an a-frame and flat mount trailer coupler;

FIG. 27 is a partially exploded isometric view of the a-frame trailer coupler in FIG. 26;

FIG. 28 is a bottom rear isometric partially exploded view of the coupler in FIG. 27;

FIG. 29 is a section view 29-29 of the coupler in FIG. 26;

FIG. 30 is an isometric view of the locking pin and related components;

FIG. 31 is a top front isometric view of an alternate mounting of the coupler in FIG. 26;

FIG. 32 is a top front isometric view of an alternate embodiment of the coupler;

FIG. 33 is an exploded isometric view of the coupler in FIG. 32;

FIG. 34 is a bottom rear exploded isometric view of the coupler in FIG. 33;

FIG. 35 is a bottom view of the coupler in FIG. 32;

FIG. 36 is a side section view 36-36 of the coupler in FIG. 35;

FIG. 37 is a bottom isometric view of an alternate embodiment of the coupler;

FIG. 38 is an exploded isometric view of the coupler in FIG. 37;

FIG. 39 is a front section view 39-39 of the coupler in FIG. 37;

FIG. 40A is a side section view 40-40 of the coupler in FIG. 37 as a hitch ball is entering the fixed ball pocket with the lever in the latched position;

FIG. 40B is a side section view 40-40 of the coupler in FIG. 37 as the hitch ball has rotationally displaced the lever away from the latched position;

FIG. 40C is a side section view 40-40 of the coupler in FIG. 37 with the hitch ball secured within the fixed ball pocket and the lever in the latched position;

FIG. 40D is a side section view 40-40 of the coupler in FIG. 37 with the lever moved to the released position; and

FIG. 40E is a side section view 40-40 of the coupler in FIG. 37 with the hitch ball moving the lever from the released position as it exits the coupler.

### DESCRIPTION OF THE PREFERRED EMBODIMENT

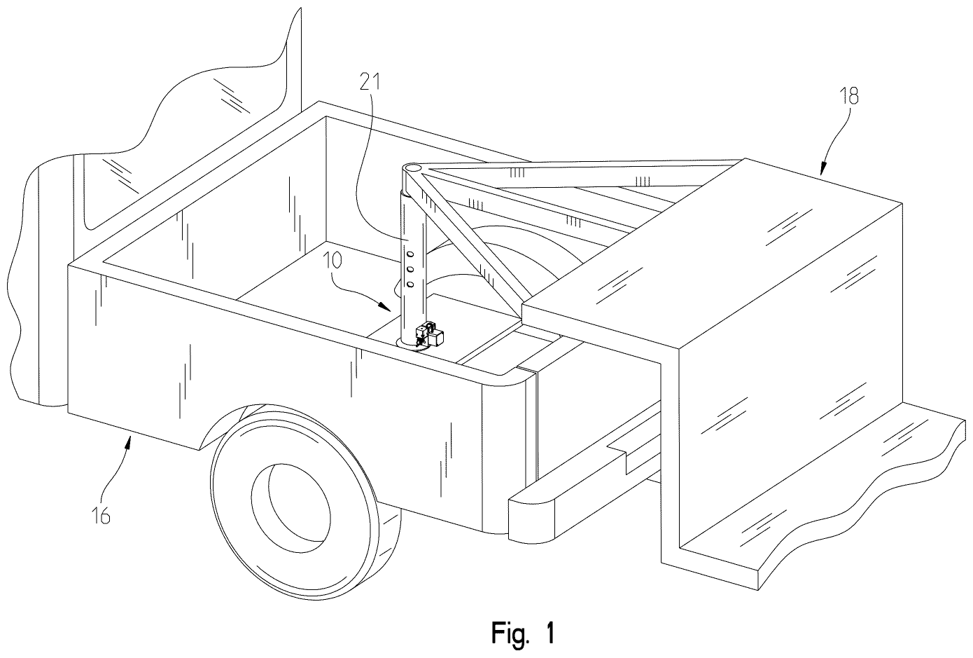

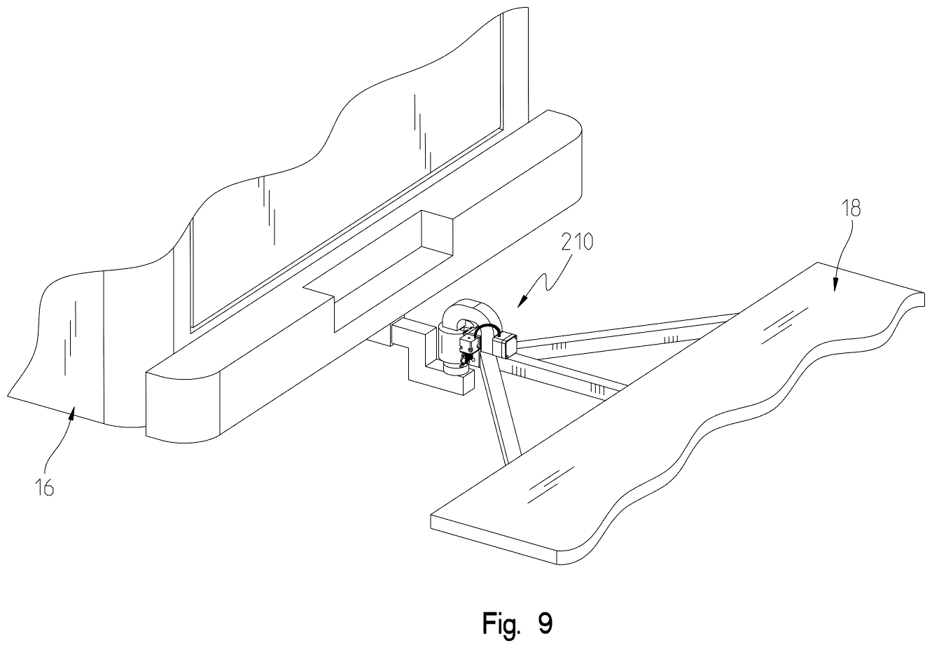

A coupler 10 is designed to mate to a standard hitch ball 12 having a partially spherical surface 14. The hitch ball 12 is typically affixed to a towing vehicle 16, either at the rear of the vehicle as shown in FIG. 9 or above an axle as shown in FIG. 1. When the hitch ball 12 is affixed to the vehicle frame above an axle, it is typically when the vehicle is set up for towing a gooseneck trailer. As is common with hitch balls, the hitch ball 12 contemplated herein has a spherical portion and a stem portion, with the stem portion being smaller than the spherical portion. The couplers discussed herein capture the hitch ball 12 by trapping the spherical portion while still allowing rotation with respect to the coupler.

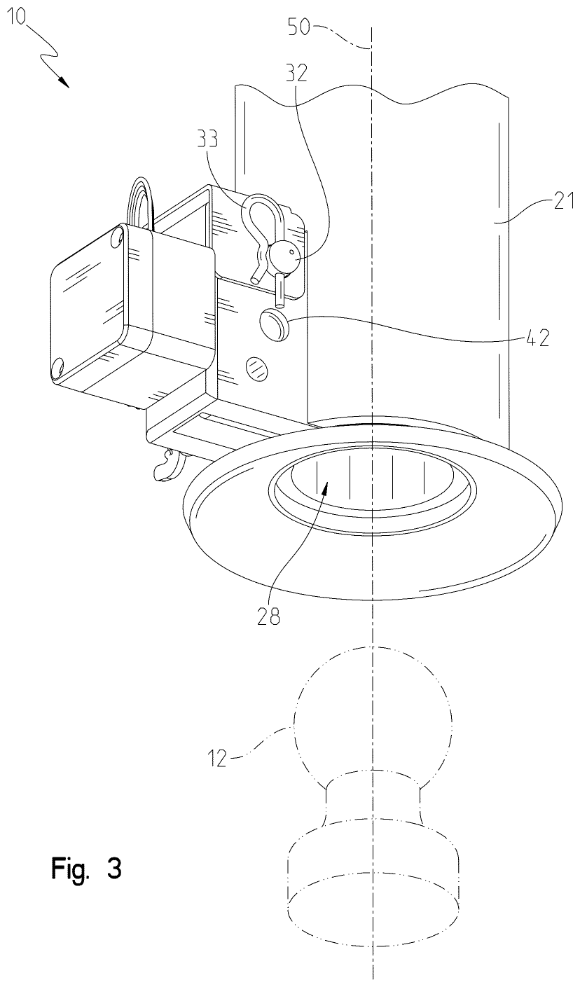

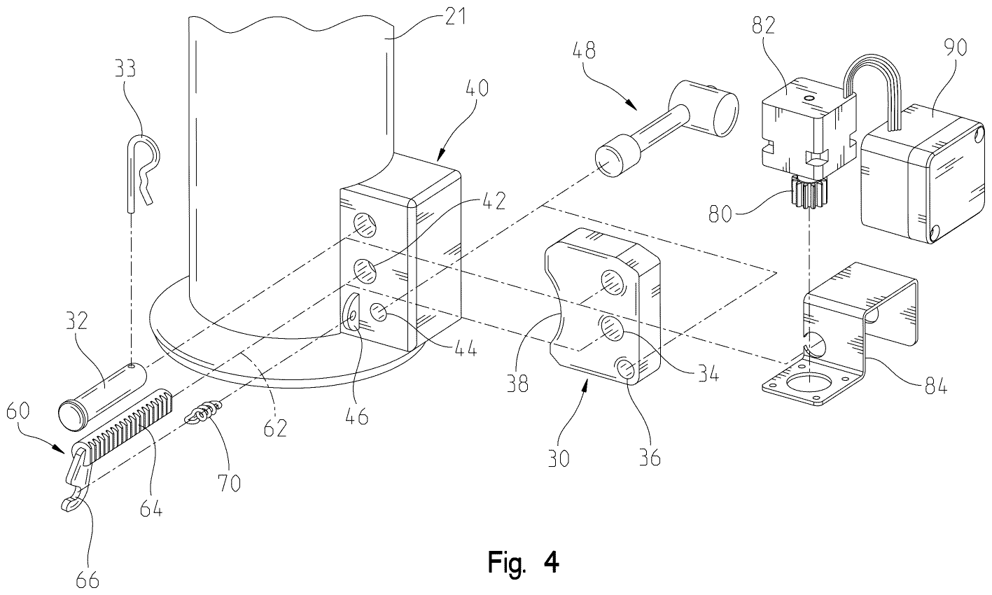

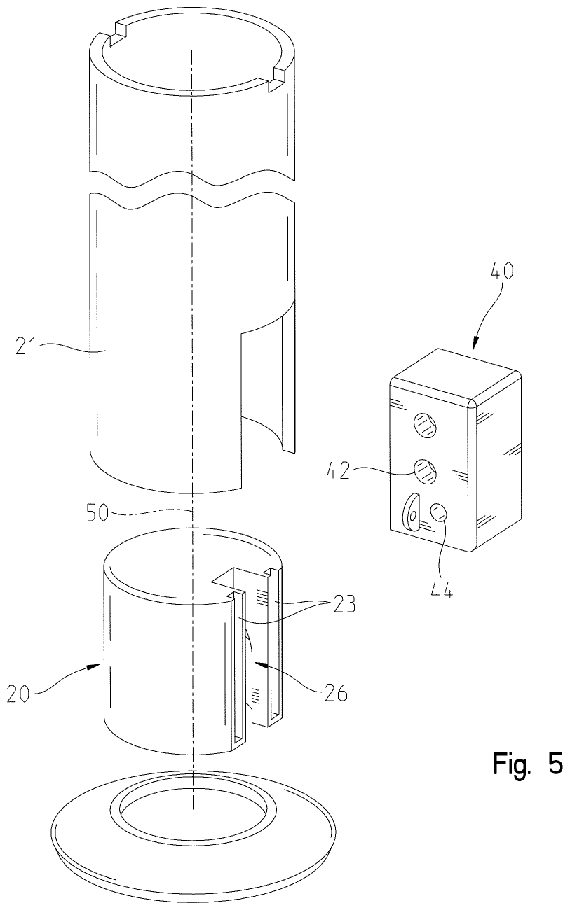

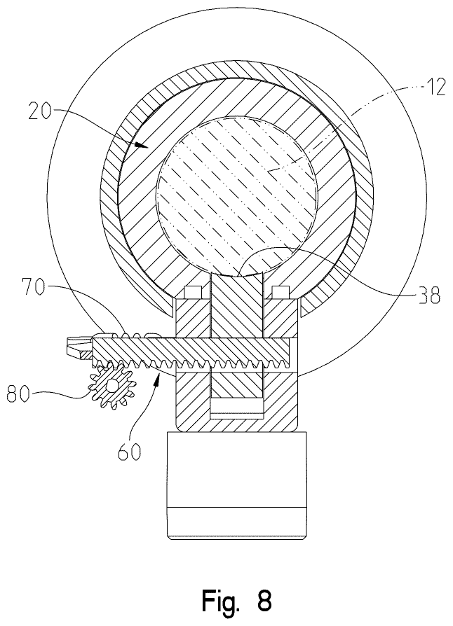

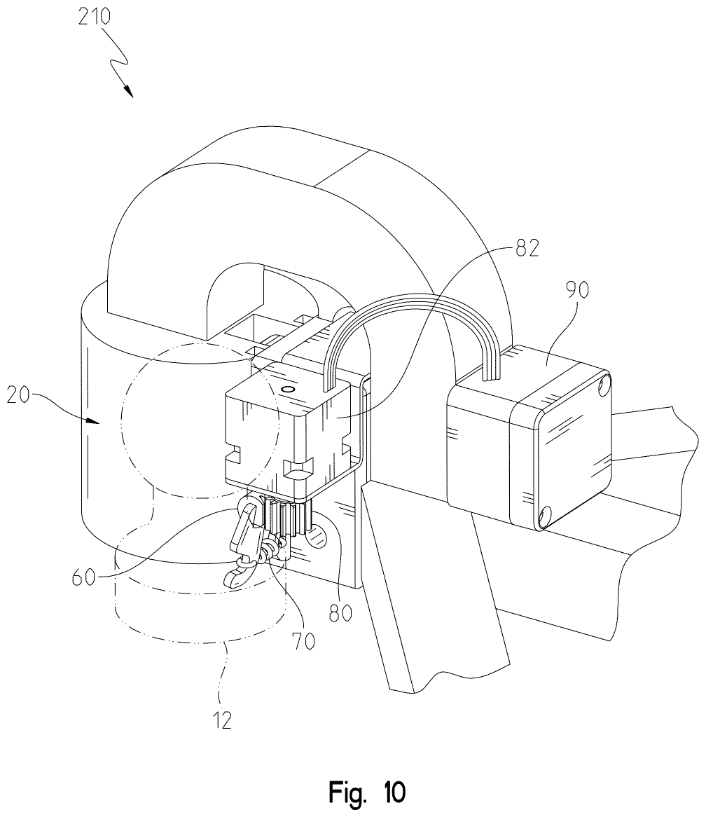

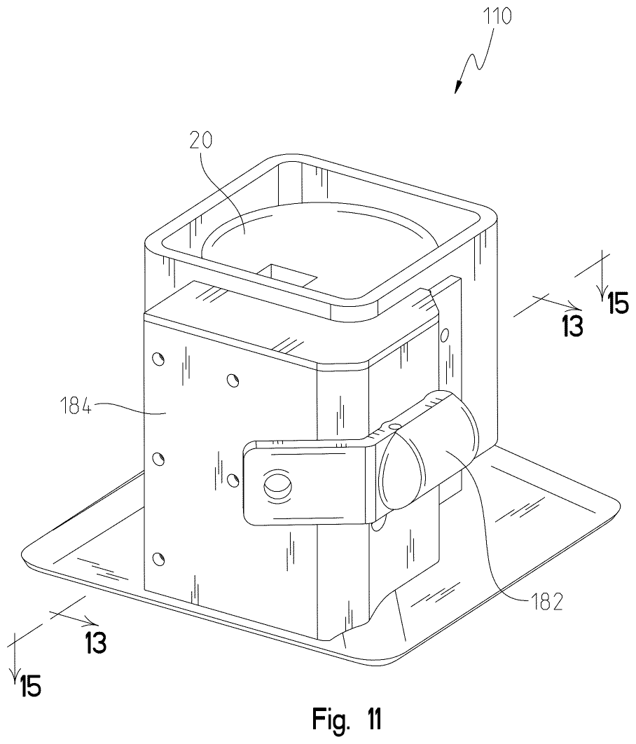

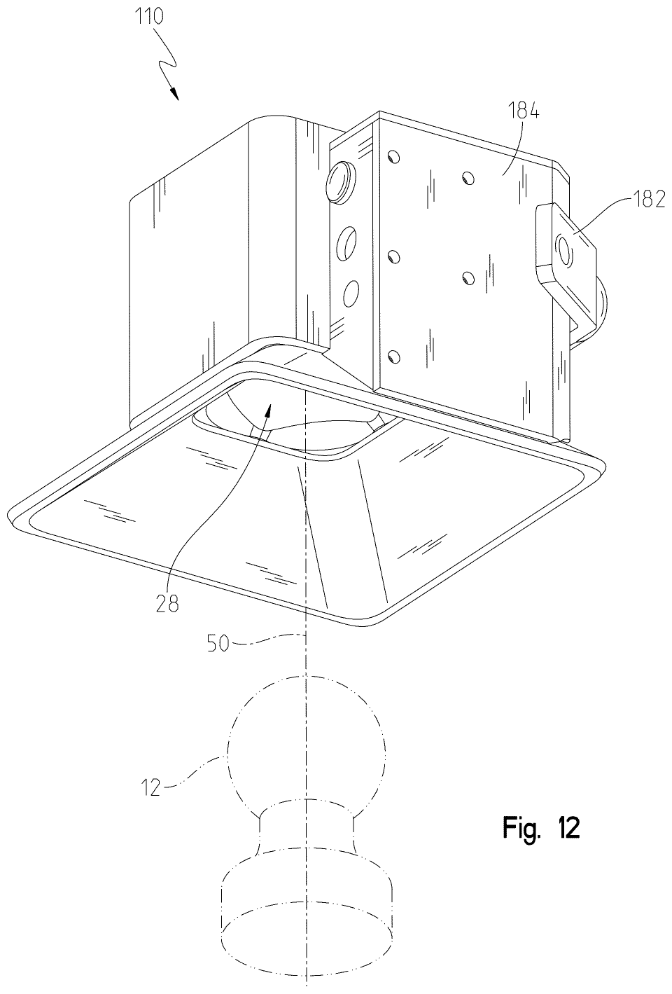

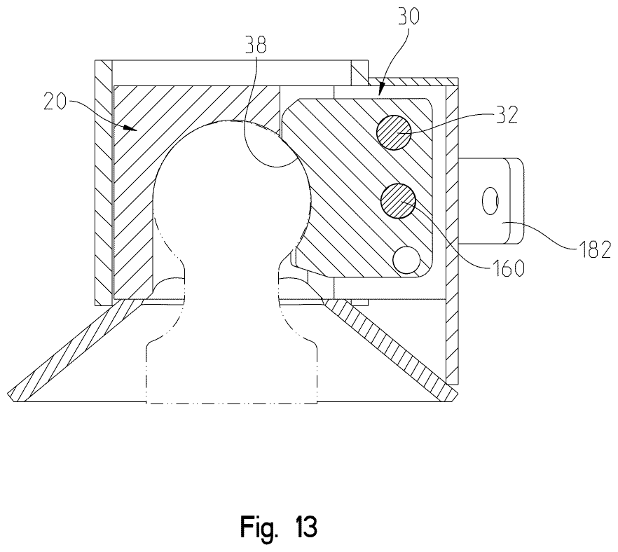

The coupler 10 shown in FIGS. 1-8 is useable with a gooseneck trailer, with a manual coupler 110 shown in FIGS. 11-16, and a bumper version of the coupler 210 shown in FIGS. 9-10 being useable with a bumper-mounted or rear-mounted hitch ball. For the purposes of simplicity, the gooseneck version of the coupler 10 will be described in detail. The bumper version of the coupler 210 will then be described to the extent that it differs from the coupler 10. In the disclosures herein, the couplers 10, 110, 210 use the same operative parts, with some structural differences being related to how the locking pin is released and/or how the coupler mounts to the trailer (not shown). The coupler 10, 110, 210 is mounted to a trailer with a coupling axis 50 perpendicular or substantially perpendicular to the ground. Because vehicles and/or trailers can be located on unlevel ground, substantially perpendicular is defined as the ball pocket being sufficiently vertical for the coupler to mate with the hitch ball 12.

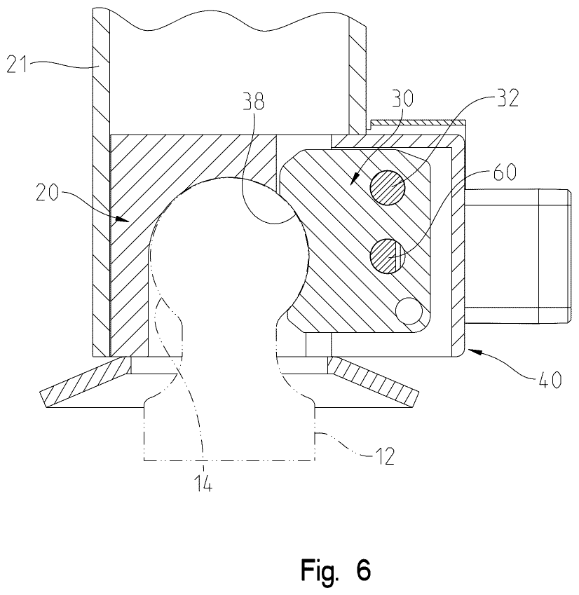

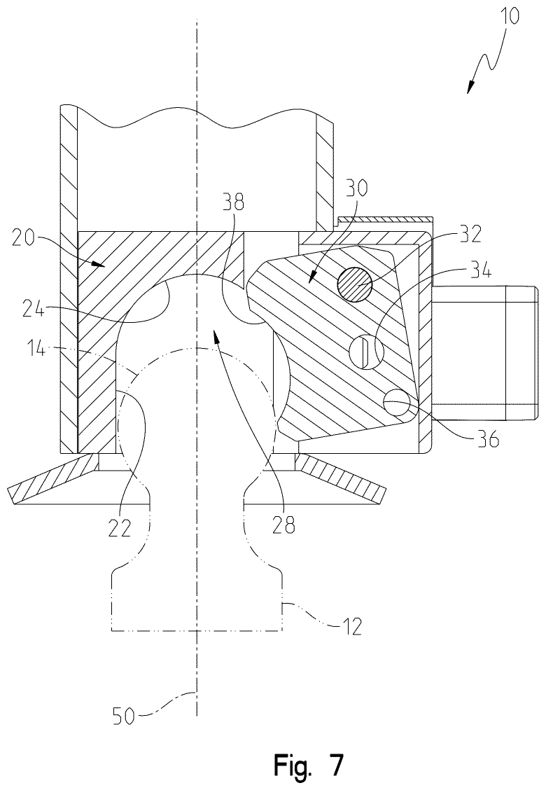

The coupler 10 has a fixed ball pocket 20 with a cylindrical inside surface 22 extending to a hemispherical surface 24. The cylindrical inside surface 22 and hemispherical surface 24 cooperate to form a partial capsule-shaped inside envelope 28. In other words, the surfaces 22, 24 combine to form one end of a spherocylindrically shaped cavity. Other names for this shape include a hemisphere cylinder. The fixed ball pocket 20 has a notch 26 that interrupts the cylindrical inside surface 22 and extends into the hemispherical surface 24. A lever 30 is retained in the notch 26 that is used to capture the hitch ball 12. The lever 30 pivots between a captured position (shown in FIG. 6) and a released position (shown in FIG. 7) about a pin 32 that is secured to a housing 40. The pin 32 is shown as being held in with a clip 33, but other methods of securing the pin 32 are contemplated. The housing 40 is fixed with respect to the fixed ball pocket 20, typically through welding. For coupler 10, the fixed ball pocket 20 and housing 40 are secured to a gooseneck tube 21 that is made to be secured to a trailer 18, as shown in FIG. 1. The fixed ball pocket 20 has grooves 23 that may be used to align with features on the housing 40, which can ensure alignment and proper positioning of the lever 30 with respect to the fixed ball pocket 20. The lever 30 is biased towards the released position through gravity, because the aperture for the pin 32 is offset from the center of gravity of the lever. It is contemplated that the lever 30 is biased with a spring or other component. The lever 30 has a locking aperture 34 that aligns with rack apertures 42 in the housing 40 when the lever is in the captured position. In the captured position, the lever 30 also has a manual locking aperture 36 that aligns with manual lock apertures 44 in the housing 40. The manual lock apertures 44 allow for a keyed or other security lock 48 to be installed. The lever 30 has a ball engagement surface 38 that is complementary to the partially spherical surface 14 of the hitch ball 12. The lever 30, and in particular, the ball engagement surface 38 portion extends into the inside envelope 28 irrespective of the lever's position. An upper portion of the engagement surface 38 extends inwardly when the lever 30 is in the release position and a lower portion of the engagement surface extends inwardly in the captured position. This is shown in FIGS. 6 and 7. At points between these two extremes, one portion or both portions extend into the inside envelope 28.

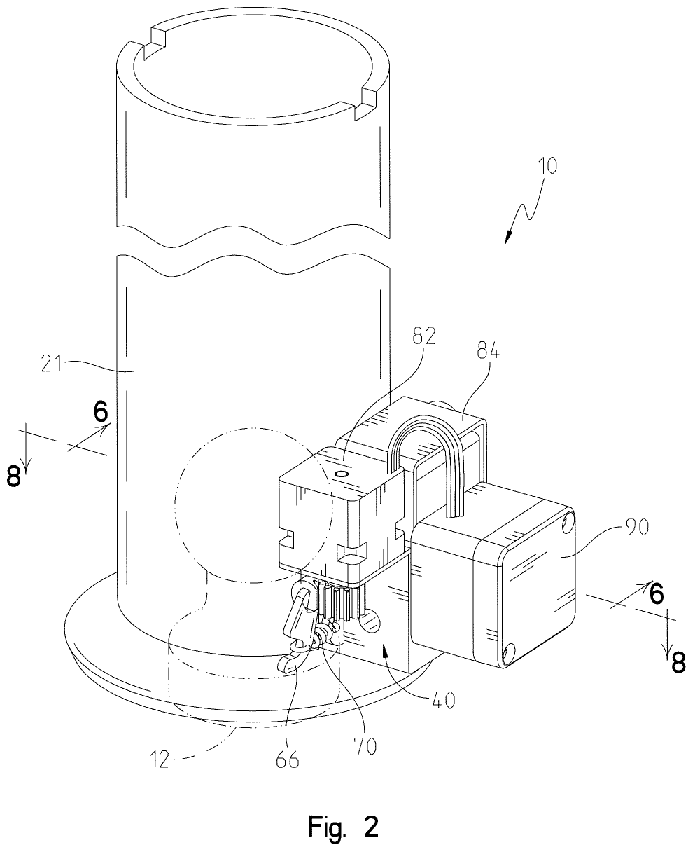

As previously disclosed, the lever 30 and housing 40 have apertures that align when the lever is in the captured position. The housing 40 includes a slidable locking pin 60 that moves along a locking axis 62 between a locked and unlocked position. The slidable locking pin 60 has a rack gear 64 and a spring hook 66. The spring hook 66 is attached to a spring 70 that is connected to the housing 40 at a spring eyelet 46. The spring 70 biases the locking pin 60 towards the locked position, which is shown in FIG. 2.

The rack gear 64 mates with a spur gear 80 that is affixed to an actuator or motor 82. The motor 82 can rotate the spur gear 80 to move the locking pin 60 along the locking axis 62. The motor 82 is mounted to a bracket 84 and is electrically connected to a control 90. While the motor 82 and control 90 are shown as separate components, it is contemplated that the control and motor are integrated into a single unit or enclosure. The control 90 houses electronics that are either battery-powered, powered from the trailer, or powered by the towing vehicle. Optionally, a sensor is located in the fixed ball pocket 20 or another location to detect the presence of the hitch ball 12. The sensor can be magnetic, proximity, or any type of sensing technology that detects the presence or movement of the hitch ball, lever, or other components discussed herein. When the hitch ball 12 seats into the fixed ball pocket 20 or is removed from it, the sensor sends a signal to the control 90. It is contemplated that the sensor is located to detect the position of the lever 30. The sensor is in electrical communication with the control 90 and can be used to notify the user of the status of the hitch and/or be used to move the motor 82. The electronics control the motor 82 and can receive signals from a wireless remote, communicate over Bluetooth, NFC, or other protocol. Bluetooth, NFC, or other protocols are used with smartphones, tablets, or other mobile devices that would have a custom program/application. The application would provide the status of the motor, sensor(s), and battery level, along with providing control for the motor to release the coupler.

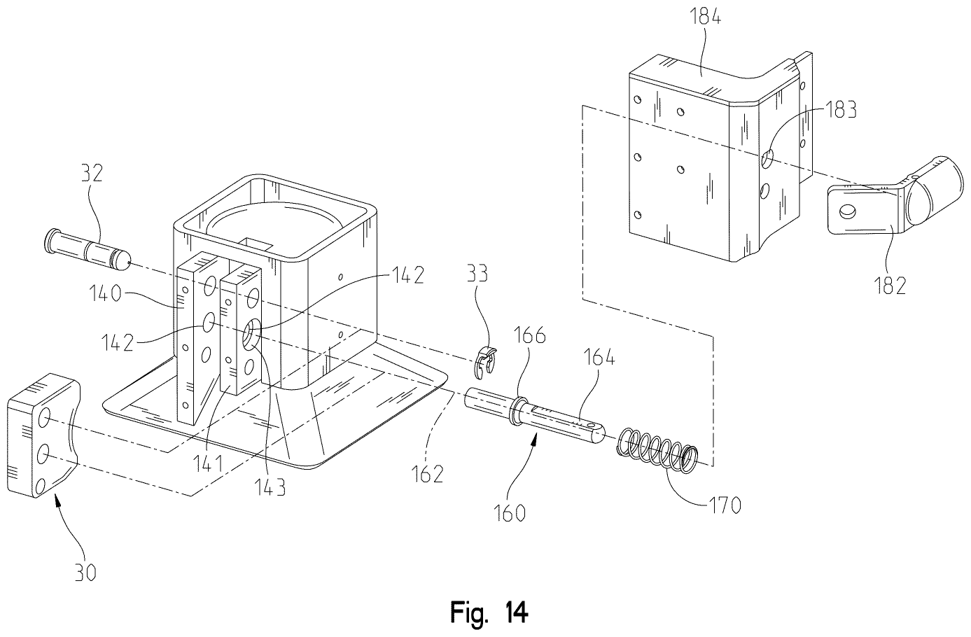

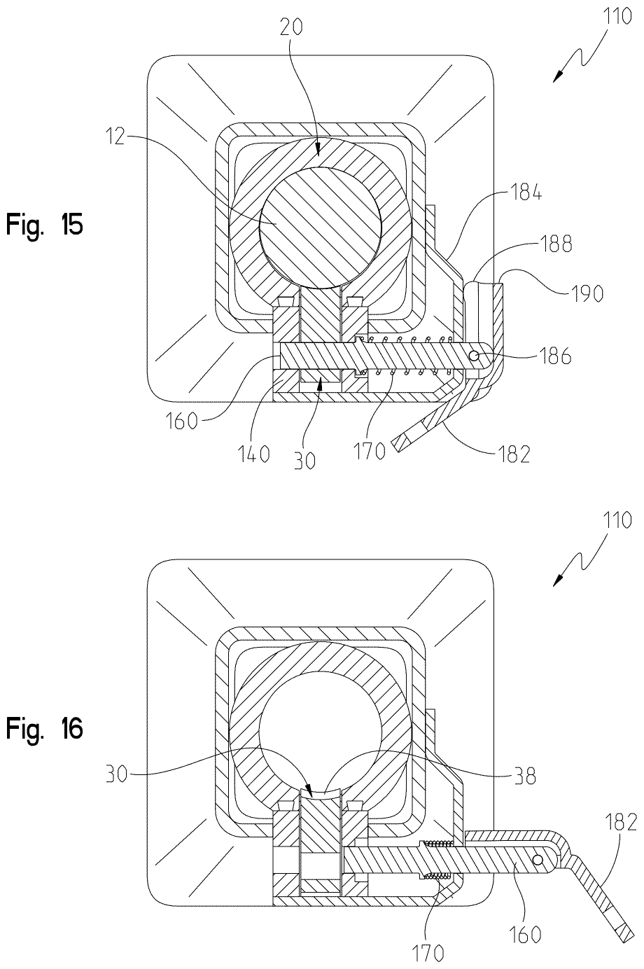

The manual version of the coupler 110 is shown in FIGS. 11-16, where the motor, controller, and optional sensor are not present. Coupler 110, like coupler 10, uses the fixed ball pocket 20 and lever 30. The differences between coupler 10 and coupler 110 are related to how the locking pin 160 is moved to the unlocked position. A first housing side 140 and a second housing side 141 cooperate with a guide bracket 184 to form a housing. The first and second housing sides 140, 141 have apertures 142 for the locking pin 160. The locking pin 160 slides along a locking axis 162, shown in FIG. 14. As shown in FIGS. 15-16, the locking pin 160 is attached to a release lever 182 and biased towards the locked position by a spring 170. The spring 170 is held between a guide bracket 184 and a step 166 located on the locking pin. The step 166 could be integrated into the locking pin 160 or be a clip (such as a c-clip or e-clip) attached thereto. The second housing side 141 has a pocket 143 to receive the step 166 in the locked position. The locking pin 160 has a guide flat 164 that cooperates with an aperture 183 in the guide bracket 184 to prevent the locking pin 160 from rotating and maintain alignment and orientation of the pin and release lever. The release lever 182 is tied to the locking pin 160 by a lever pivot 186 which allows the release lever 182 to pivot with respect to the locking pin 160. The release lever 182 has a rounded surface 188 that slides along the guide bracket 184 and an end surface 190 that can hold the locking pin 160 in the unlocked position.

The bumper version of the coupler 210 is shown in FIGS. 9-10 and may either be manual, like coupler 110 or electrically-actuated like coupler 10.

As previously described, the coupler 10, 110, 210 releases and captures the hitch ball 12 through the movement of the lever 30. When the hitch ball 12 absent from the inside envelope 28 and the locking pin 60, 160 is in the unlocked position, the lever 30 is free to move between the release and capture positions but will naturally rotate to the release position through gravity. This puts the coupler 10, 110, 210 into a condition to receive the hitch ball 12. The upper portion of the engagement surface 38 extends into the inside envelope 28 in this position. At the same time, the locking pin 60, 160 is biased towards the locked position but cannot reach it because the locking aperture 34 is not aligned. Instead, the locking pin is biased against the side of the lever 30. When the hitch ball 12 is moved into the inside envelope 28, it meets the upper portion of the engagement surface 38, where it begins to rotate the lever 30 towards the captured position. As the hitch ball 12 reaches a fully seated position against the hemispherical surface 24, the lever 30 reaches the captured position, which aligns the locking aperture 34 with the locking pin 60, 160. The bias pressure on the locking pin (from the spring 70, 170) causes it to extend through the locking aperture 34 completely and through apertures 42, 142. The hitch ball 12 is held in place by the lower portion of the engagement surface 38 while the lever 30 is locked from rotating by the locking pin. To release the hitch ball 12, the user pulls the locking pin 60, 160 out of the locking aperture 34. For the manual versions, this is done by actuating the handle 182, while in the electrically-actuated version it is moved by the motor 82. Removing the locking pin from the locking aperture allows the lever 30 to swing to the released position, thereby allowing the hitch ball 12 to withdraw.

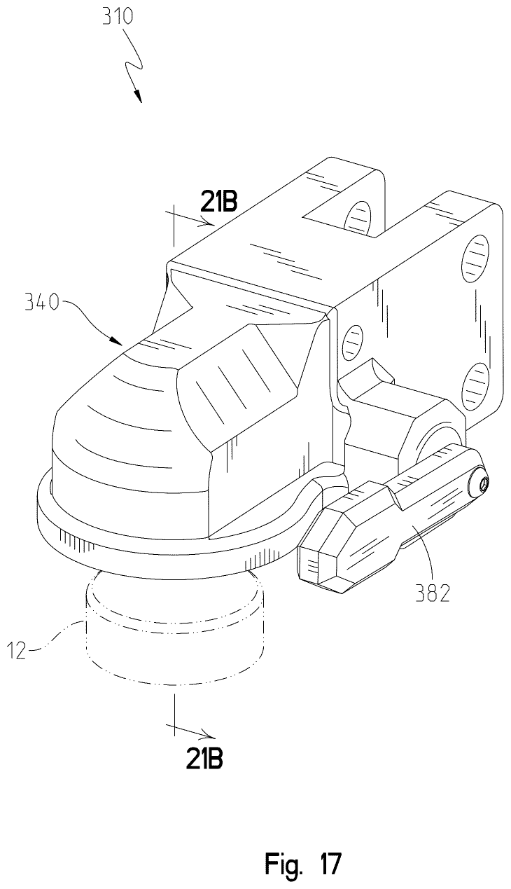

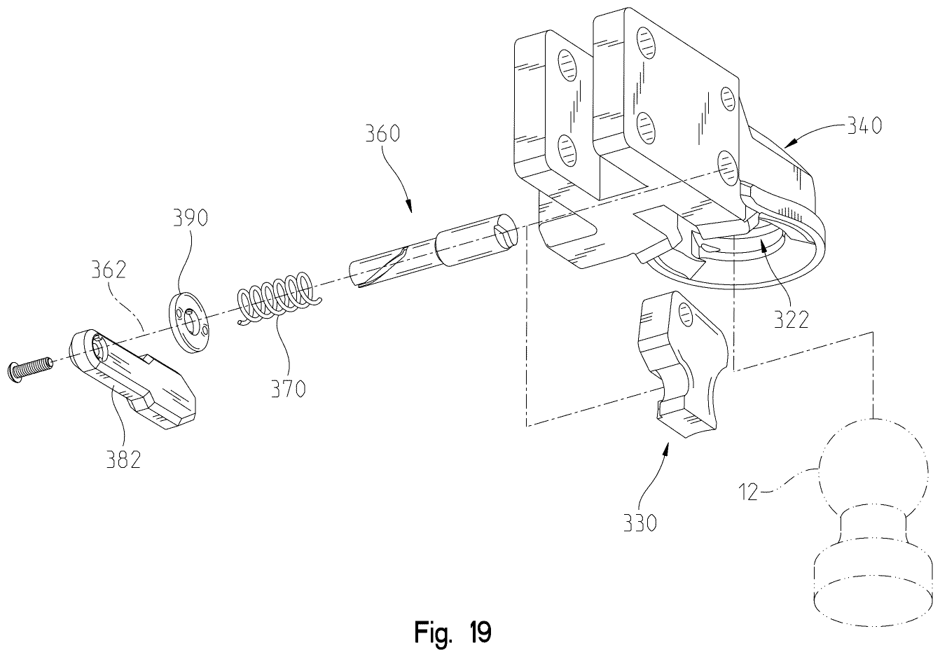

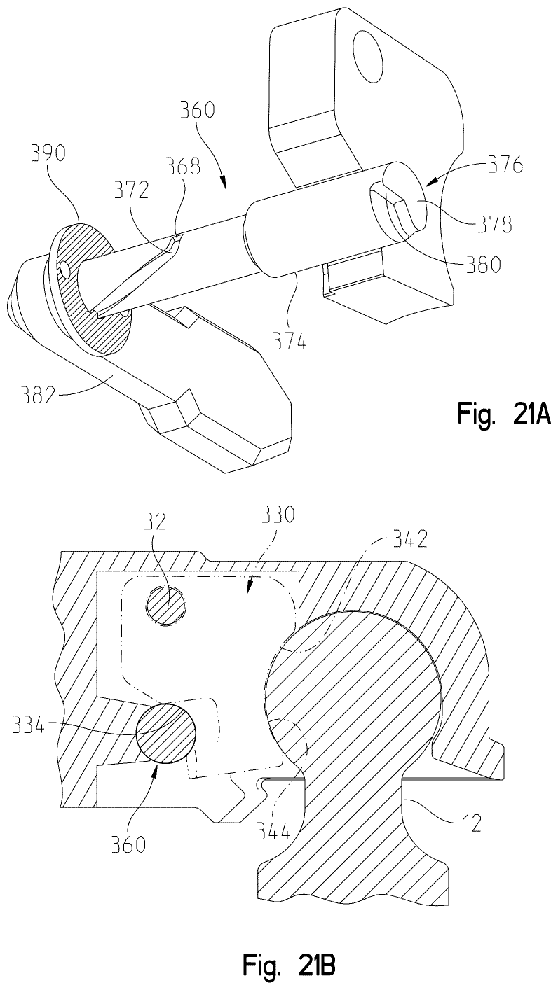

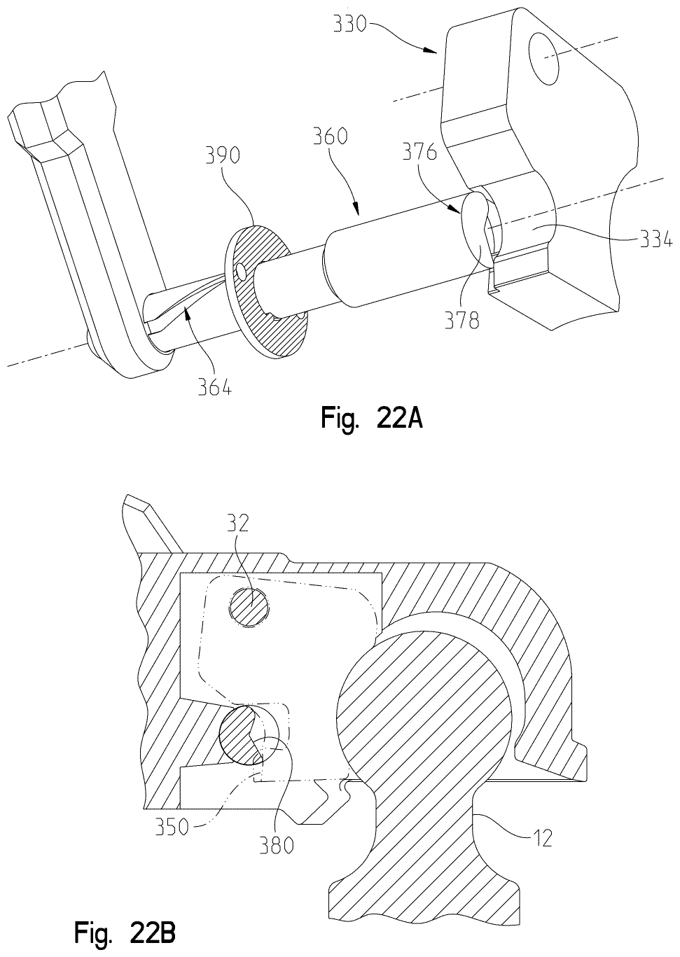

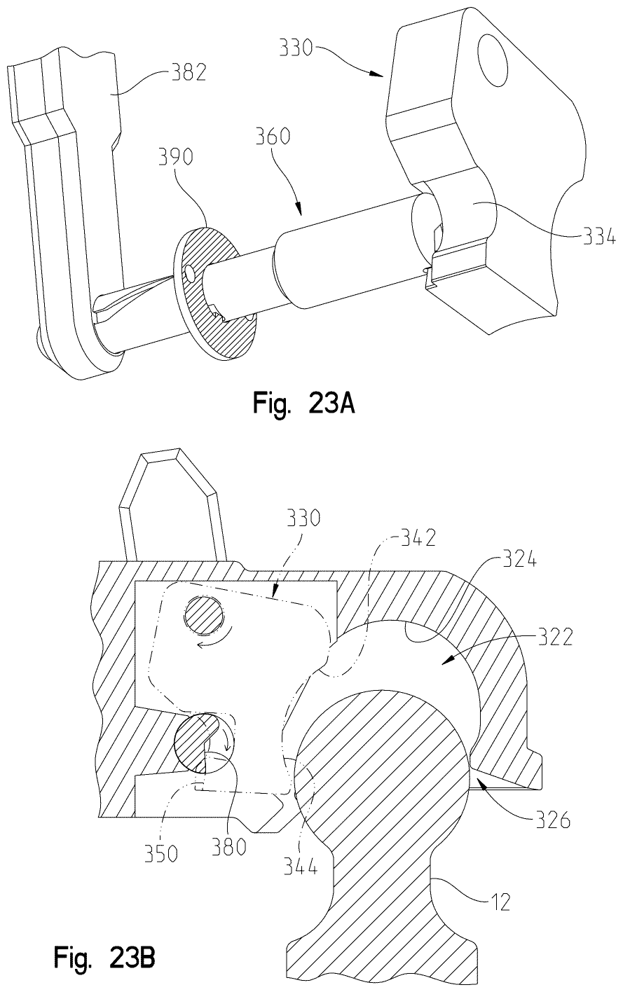

Coupler 310 is shown in FIGS. 17-19 and shares many of the same features as couplers 10, 110, 210 with a fixed ball pocket 322 having a hemispherical surface 324 on a housing 340. The fixed ball pocket 322 has an opening 326. As with the other couplers, coupler 310 includes a lever 330 that pivots between a captured position (shown in FIG. 21B) and a released position (shown in FIG. 23B) about a pin 32. Located between the captured and release position is a reset position, shown in FIG. 22B. A release handle 382 is attached to the locking pin 360, which allows it to rotate around and slide along a locking axis 362.

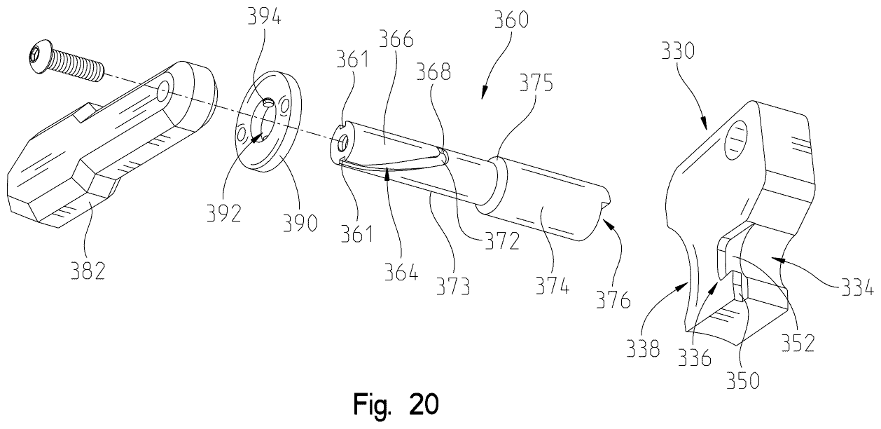

The locking pin 360 contains additional features, such as a pair of modified helical grooves 364. As shown in FIG. 20, the grooves 364 are located on a minor diameter 366 of the locking pin. The grooves 364 begin on an open end 361 of the locking pin and are diametrically opposed from each other. The grooves 364 spiral around and terminate at an end 368. Adjacent the end 368 is a knee 372 where the groove changes direction and turn back towards the end of the locking pin. In other words, the knee 372 is a slope change or tipping point along the length of the pin. As will be described later, the knee 372 represents a point where the locking pin 360 moves to either a locked position or an unlocked position. The locking pin 360 has a minor diameter 373, a major diameter 374, and a shoulder 375 therebetween. A trip cam 376 is located on a terminal end of the major diameter. The trip cam 376 is shown in FIG. 21 where a biasing surface 378 and a trip surface 380 are located. As will be described later, the trip cam 376 mates with surfaces and features that form a trip notch 336 on the lever 330.

Affixed to the housing 340 is a guide collar 390 with a central aperture 392. Protruding into the central aperture are guide posts 394. The guide posts 394 are diametrically opposed and are sized to accommodate the grooves 364. The central aperture is sized to allow the minor diameter 366 to slide through while the guide posts 394 cooperate with the grooves 364 to rotate the locking pin 360 on its locking axis 362.

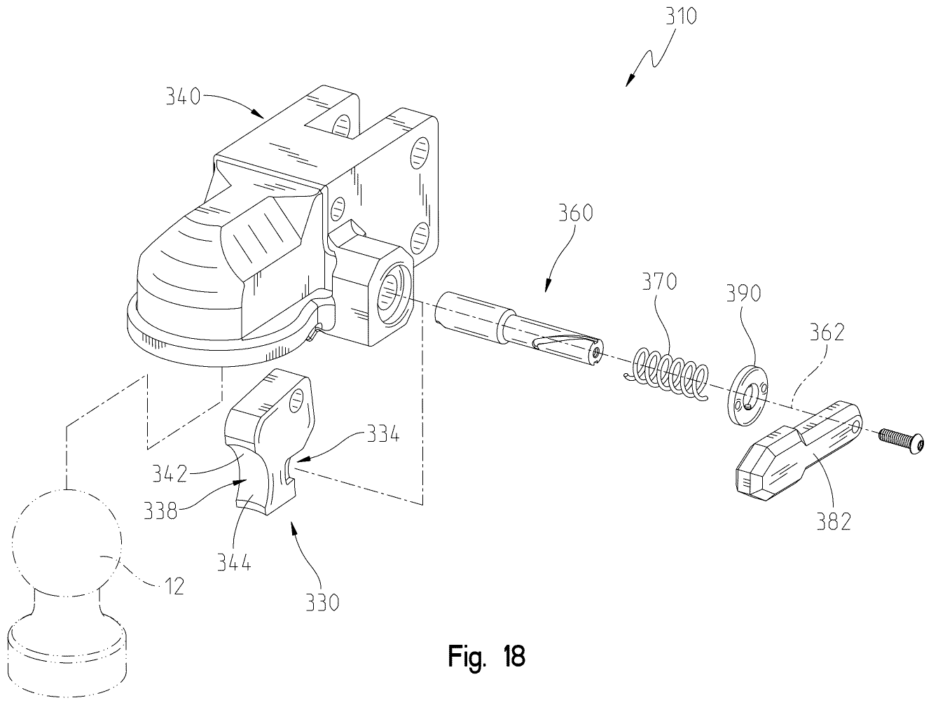

A spring 370, shown in FIG. 18, is located over the minor diameter 366, which provides the biasing force to move the pin to the locked, armed, and release positions. For clarity, the spring 370 is not shown in all figures.

The lever 330 includes the trip notch 336 that cooperates with the trip cam 376. The trip notch 336 has a resetting surface 350 and a biased surface 352. The lever 330 rotates between a captured position (FIG. 21), a released position (FIG. 22), and a reset position (FIG. 23). In the captured position, the locking pin 360 overlays a locking surface 334, which prevents the lever 330 from moving away from the captured position. In the reset position, the locking pin 360 is clear of the lever 330, which allows it to rotate about the pin 32. However, the lever 330 in the reset position does not rotate enough to fully clear the hitch ball 12 to allow it to be inserted or removed. In the release position, the hitch ball 12 can be inserted or removed. The lever 330 includes an engagement surface 338 which contacts the hitch ball 12. The engagement surface 338 has an upper portion 342 and a lower portion 344. The upper and lower portions 342, 344 engage with the hitch ball 12 in different ways and at different times, based on the position of the lever 330 and engagement position of the hitch ball 12. For example, in the locked position shown in FIG. 21B, the engagement surface 338 is aligned with the outside surface of the spherical portion of the hitch ball and the lower portion 344 extends partially across the opening 326 to capture the spherical portion of the hitch ball 12. In other words, the distance across the opening in the locked position is smaller than the spherical portion of the hitch ball, as shown in FIG. 21B. In the release and reset positions, the upper portion 342 extends into the hemispherical surface 324 of the fixed ball pocket 322, shown in FIGS. 22B and 23B.

In cooperation with the lever, the locking pin 360 is moveable between a locked position (FIG. 21A), an armed position (FIG. 22A), and a released position (FIG. 23A). In all of these positions, the guide posts 394 are located in different areas of the grooves 364. This is shown in FIGS. 21-23. In the released position, the guide posts 394 are located in the end 368. In the locked position, the guide posts are at the terminal end of the grooves 364 adjacent the release handle 382. In the armed position, the guide posts 394 are located adjacent the knee 372 and on the opposite side of the knee from the end 368. In other words, in the armed position, the guide posts 394 are located between the knee 372 and the open end 361.

To move the coupler 310 to receive or release a hitch ball, the user first moves the locking pin 360 to the released position by pulling and rotating the release handle 382 until it is in the released position. When the locking pin is in the released position, the guide posts 394 are located in the ends 368. As the hitch ball 12 is installed or removed, the lever 330 rotates towards the reset position, which causes the resetting surface 350 to contact the trip surface 380. As the hitch ball 12 continues to rotate the lever 330, the resetting surface 350 continues to contact the trip surface 380, which causes the locking pin 360 to rotate and move the guide posts 394 from the ends 368 and over the knee 372 to the armed position. At this point, the locking pin 360 is biased against the lever 330 with the biasing surface 378 in biased contact with the biased surface 352. As the hitch ball moves into the housing and the lever 330 rotates to the captured position, the locking surface 334 clears the locking pin 360, allowing the pin to freely slide to the locked position.

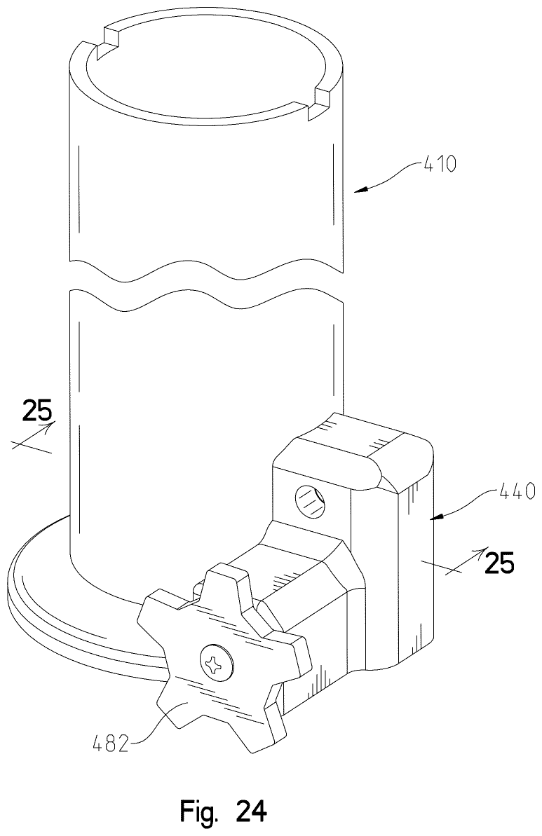

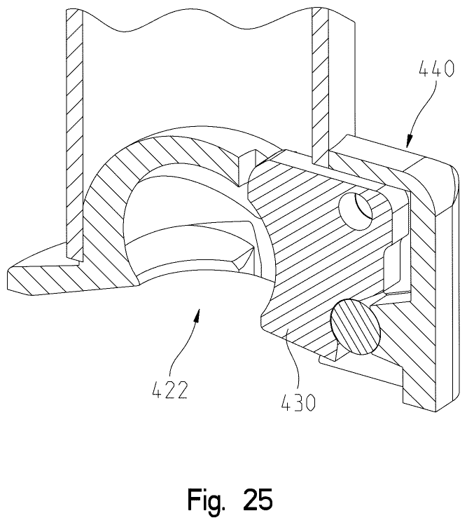

Coupler 410 is shown in FIGS. 24-25 and contains many of the same features and components as coupler 310. For example, coupler 410, has a fixed ball pocket 422, housing 440, lever 430, and release handle 482. Aside from minor visual differences, the main difference between coupler 410 and coupler 310 is that coupler 410 is configured to attach to a gooseneck trailer.

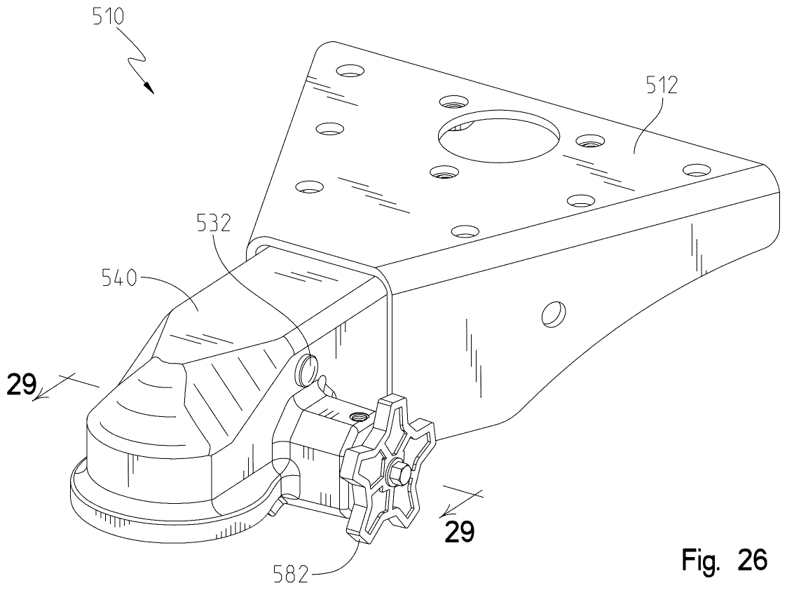

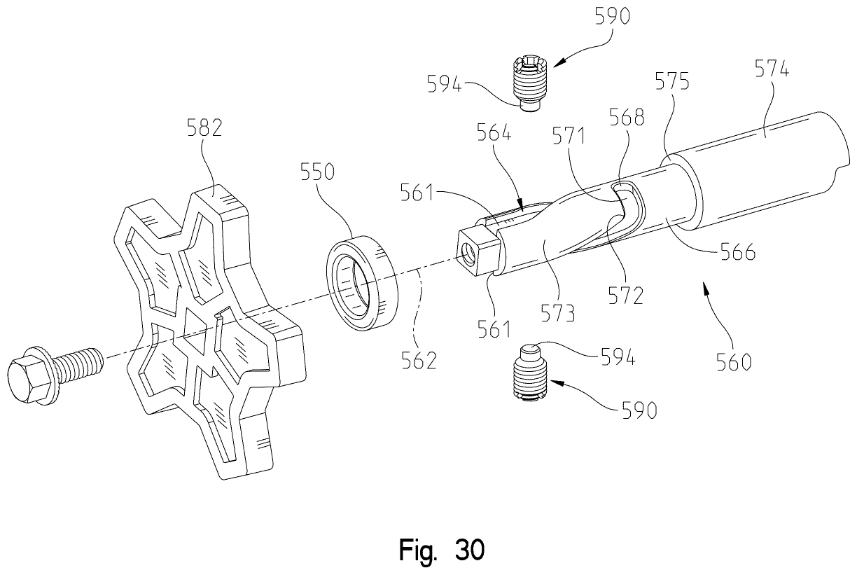

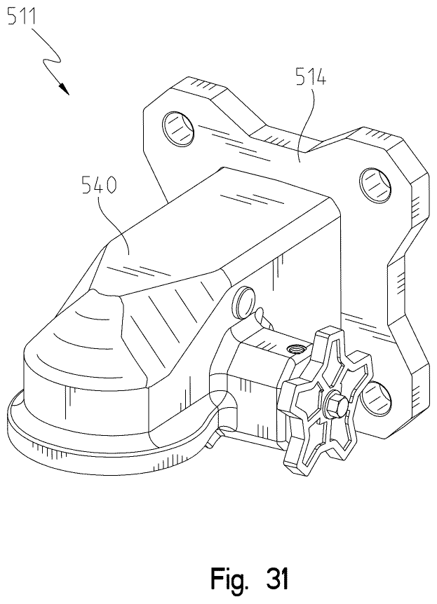

Coupler 510 shown in FIGS. 26-30 and coupler 511 shown in FIG. 31 are identical to each other, except for the bracketry used for mounting it to a trailer. Coupler 510 includes a mounting 512 for an “A frame” style trailer, while coupler 511 includes a flat mount bracket 514. Couplers 510, 511 also share many of the features of couplers 310 and 410 with certain differences noted below. Because coupler 511 is otherwise identical to coupler 510, only one will be described in detail.

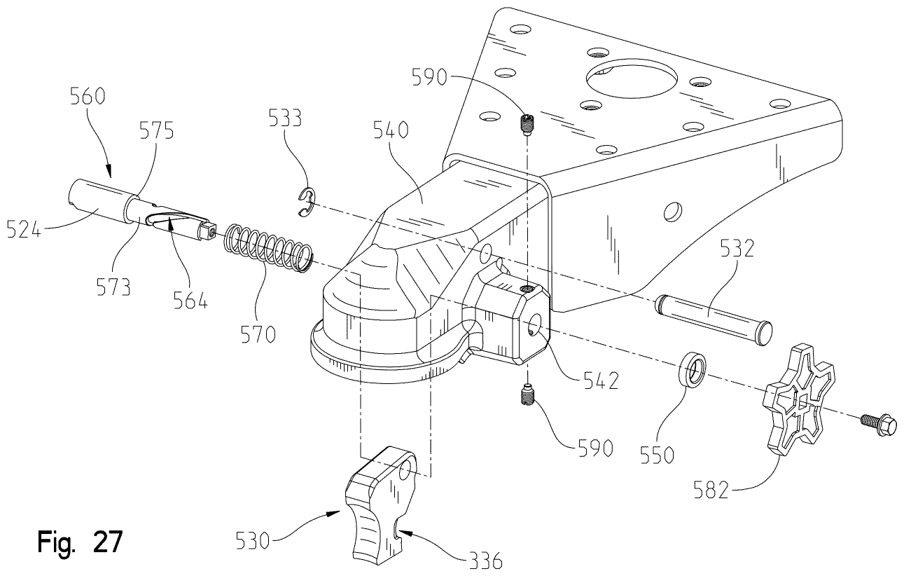

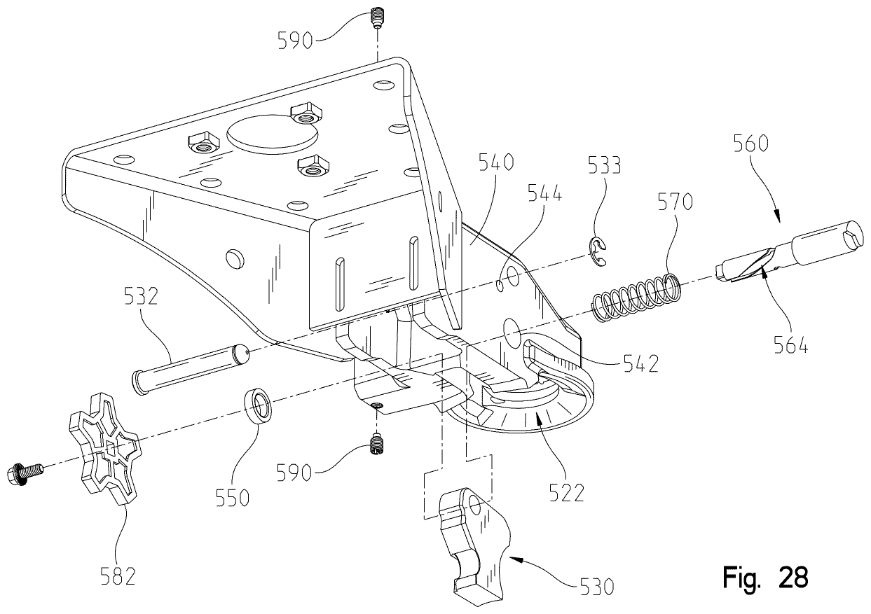

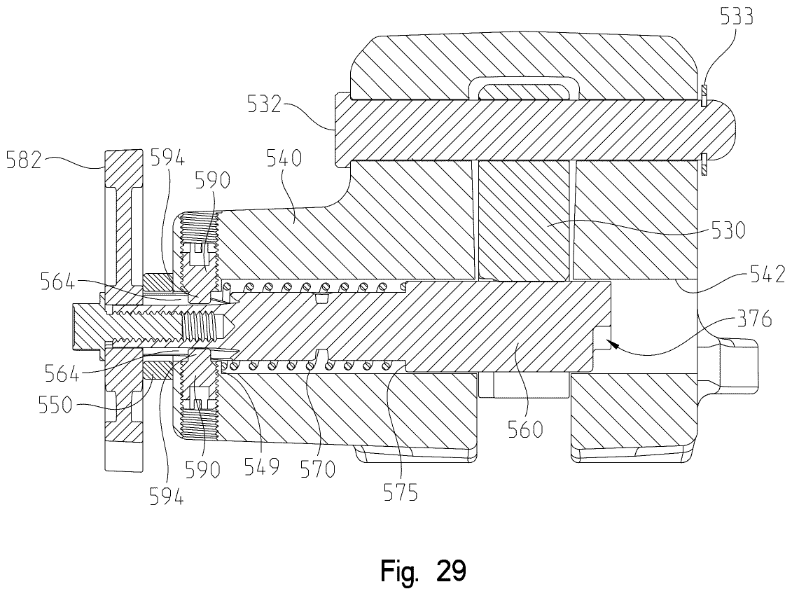

As shown in FIGS. 27-28, the coupler 510 has a housing 540 with a fixed ball pocket 522. The housing 540 holds a pin 532 that is retained with a clip 533. The pin 532 holds a lever 530 that pivots between a captured, reset, and released position, and contains the same features as levers 330, 430. The lever 530 has the trip notch 336 and related surfaces as shown in FIG. 20. The lever 530 interfaces with a locking pin 560, shown in FIGS. 27-30. The locking pin 560 has a trip cam 376 and related surfaces shown as shown in FIG. 21A. The locking pin 560 has a major diameter 574, minor diameter 573, and a shoulder 575 therebetween. The locking pin 560 has helical grooves 564 that are different than helical grooves 364. Helical grooves 564 have an open end 561, end 568, and knee 572, but there is a radial portion 571 of the groove between the knee 572 and end 568 that is purely radial and does not turn back towards the end of the locking pin 560. Instead, it remains at a constant distance from the end of the locking pin 560. Screw in guides 590 each have a guide post 594 that remain in its corresponding groove 564 to guide the rotation of the locking pin 560. The engagement of the guide posts 594 to the grooves 564 is shown in FIG. 29. The locking pin 560 is held in a locking pin aperture 542, which allows movement of the locking pin 560 along and around a locking axis 562. A spring 570 is held between the shoulder 575 and a spring backstop surface 549 in the housing 540. As shown in FIG. 29, located between a release handle 582 and housing 540 is a seal or resilient spacer 550.

The trip cam 376, trip notch 336, and how the two cooperate is described in detail above, so only the differences specific to the locking pin 560 and lever 530 will be described. The locking pin 560 is moveable between a locked position, and armed position, and a released position through the operation of the release handle 582 or lever 530. In all of these positions, guide posts 594 remain in the grooves 564. In the released position, the guide posts 594 are in the radial portion 571. In the armed position, the guide posts 594 are between the knee 572 and the open end 561. The lever 530 pivots between a captured, released, and reset positions, described above.

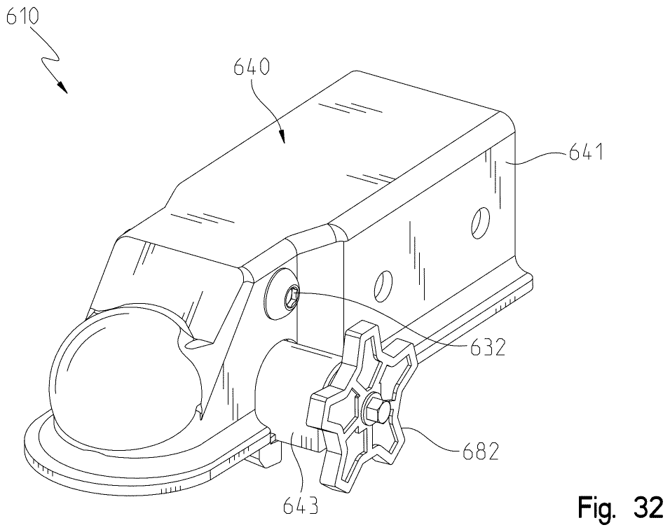

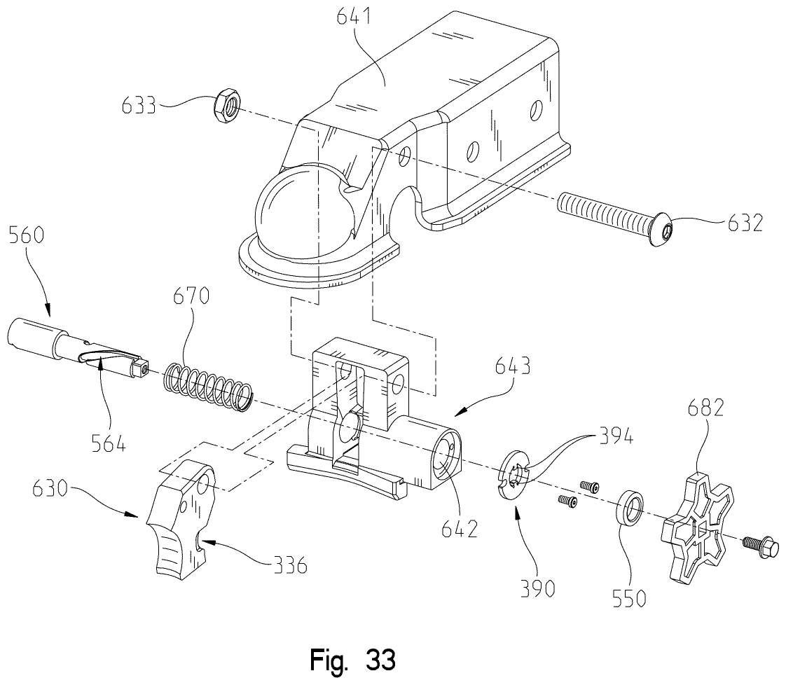

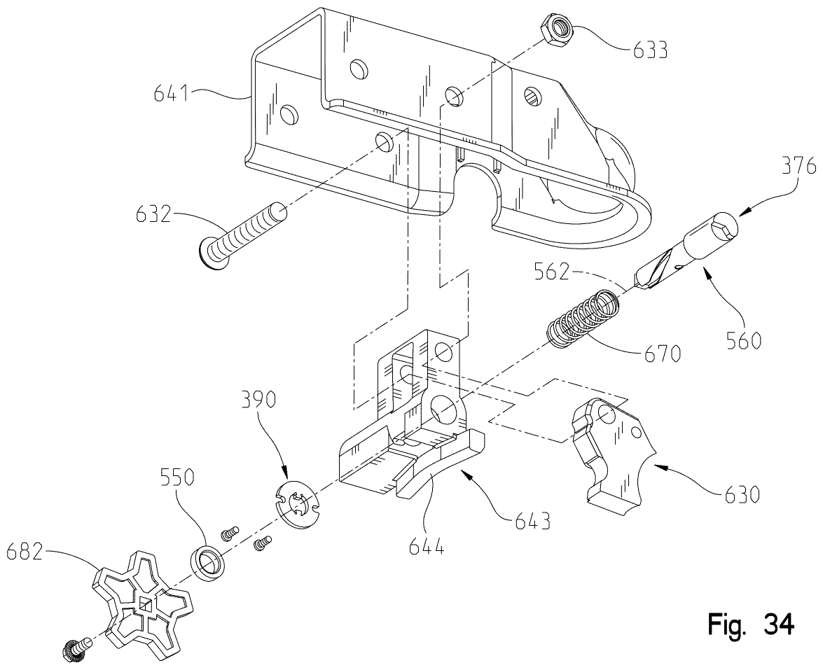

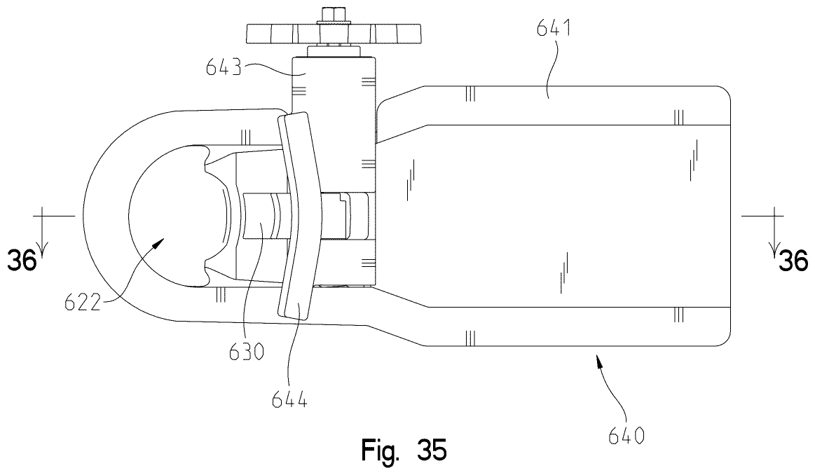

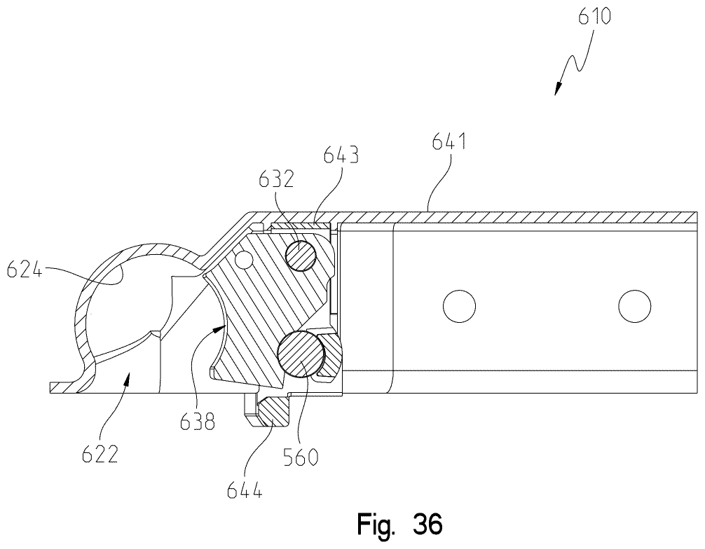

Coupler 610 shown in FIGS. 32-36 has a different construction than couplers 510, 511 but otherwise operates using the same principles. The housing 640 is formed from two separate components, a formed or stamped housing portion 641 and an insert portion 643. The insert portion 643 is cast or machined from a solid piece of metal and retained to the stamped housing portion 641 with fasteners, welding, or a combination thereof. The housing 640 has a hemispherical surface 624 in a fixed ball pocket 622, shown in FIG. 36. The insert portion 643 has a locking pin aperture 642 that holds the locking pin 560. The insert portion 643 has a guard wall 644 that extends across the notch where the lever 630 is retained. The guard wall 644 connects sides of the insert portion 643 and prevents the hitch ball 12 from contacting the bottom of the lever 630 when the hitch ball is misaligned from the fixed ball pocket 622. The locking pin 560 and spring 670 are retained in the locking pin aperture 642 with the guide collar 390 having guide posts 394. The guide collar 390 is affixed to the housing 640 with fasteners. The guide posts 394 are located in the helical grooves 564 that guide the movement of the locking pin 560. The locking pin 560 interfaces with a lever 630 that has the trip notch 336. The lever 630 is retained by and pivots about a fastener 632 and a lock nut 633 that also retain the insert portion 643 to the stamped housing portion 641, shown in FIGS. 33 and 34. The fastener 632 extends through the insert and stamped housing portions 643, 641 as shown in FIGS. 33 and 34. A release handle 682 is affixed to the locking pin 560 with a seal 550 sandwiched between the guide collar 390 and release handle 682. The locking pin 560 passes through the spacer/seal 550, which acts as a resilient damper when the locking pin moves to the locked position.

For couplers 510, 511, and 610, the lever 530, 630 moves between a captured position, release position, and a reset position. As previously described, the captured position retains the hitch ball 12 while the release position allows the hitch ball 12 to enter or exit the fixed ball pocket 522, 622. The reset position of the lever 530, 630 is located between the captured and release positions and is defined by the angular position of the lever 530, 630 where the trip notch 336 contacts the trip cam 376. Continued movement of the lever 530, 630 from the reset position to the release position rotates and moves the locking pin 560 from the released position to the armed position. When the guide posts 394 are located in the radial portion 571 (between the knee 572 and the end 568), the locking pin 560 is in the release position. When the lever 530, 630 is moved from the reset position to the release position, the trip notch 336 engages the trip cam 376 to move the locking pin 560 from the release position. The guide posts 394, 594 are moved from the radial portion 571 over the knee 572, which puts the locking pin 560 in the armed position and in biased contact with the side of the lever 530, 630. When the hitch ball 12 is moved into the fixed ball pocket 522, 622, the lever 530, 630 returns to the captured position, allowing the locking pin 560 to rapidly move to the locked position. The spring 570, 670 provides the biasing force on the locking pin 560. The resilient spacer 550 acts as a cushion when the locking pin 560 moves from the released or armed position to the locked position. In the locked position, the spring 570, 670 maintains biased contact on the resilient spacer 550 between the release handle 582, 682 and housing.

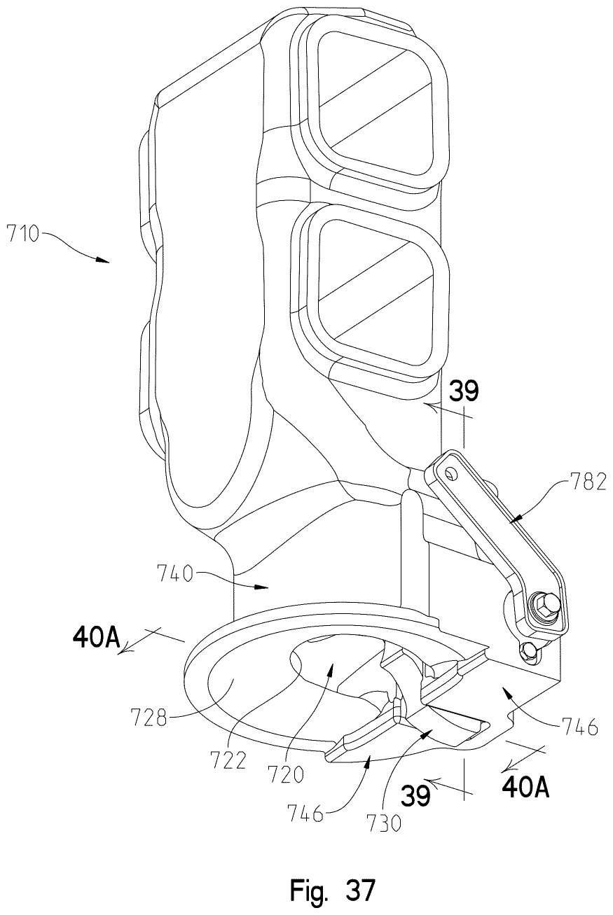

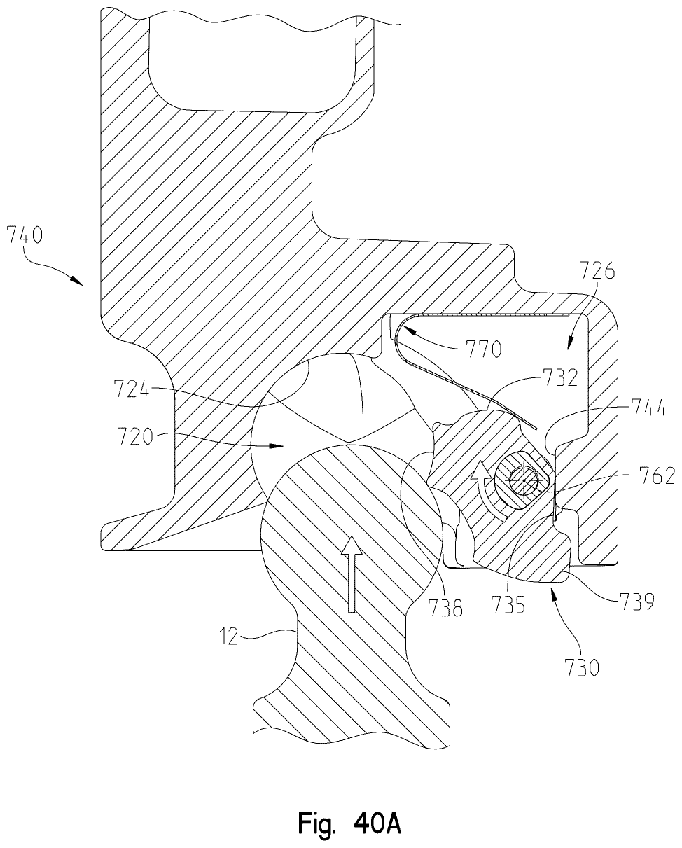

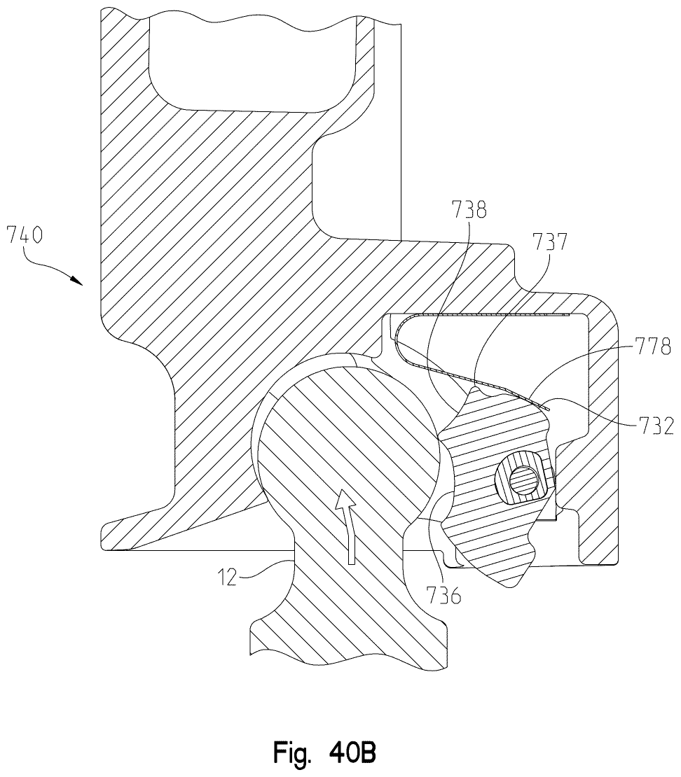

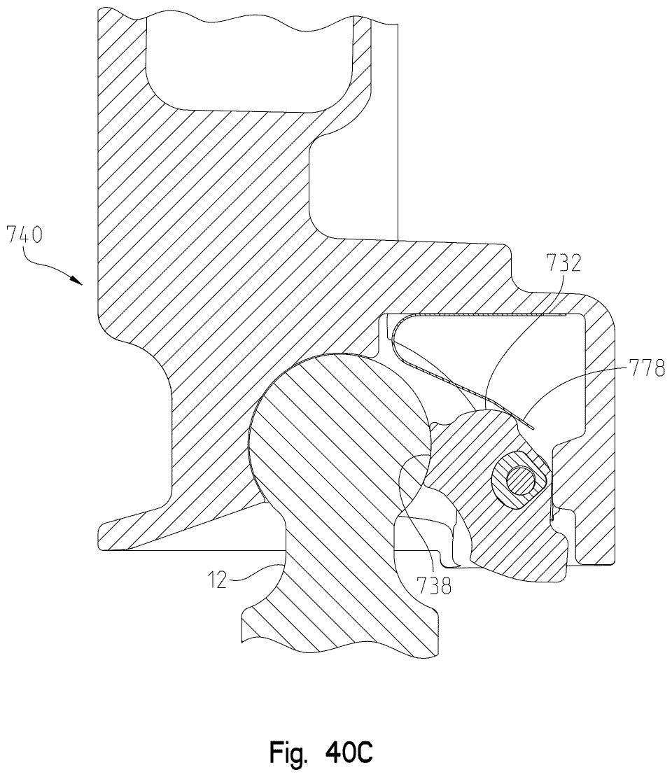

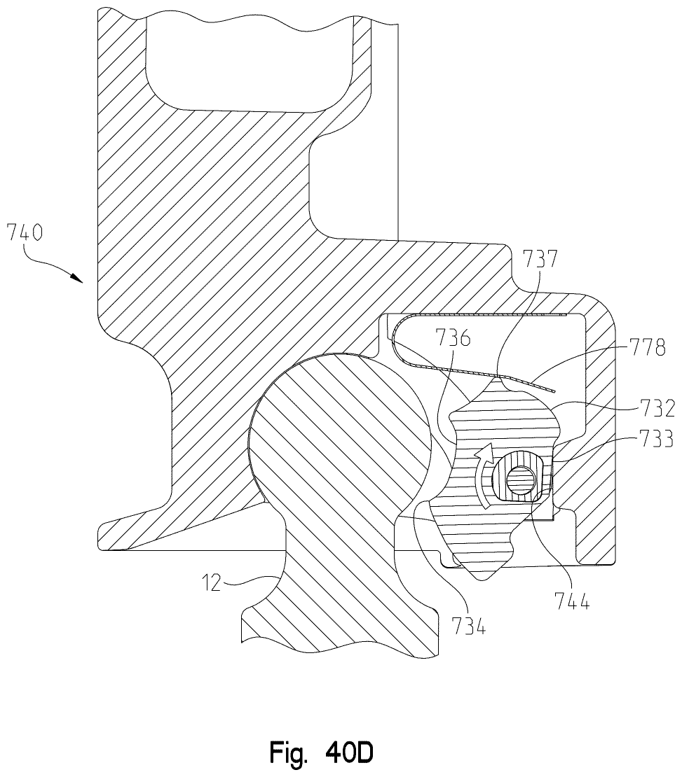

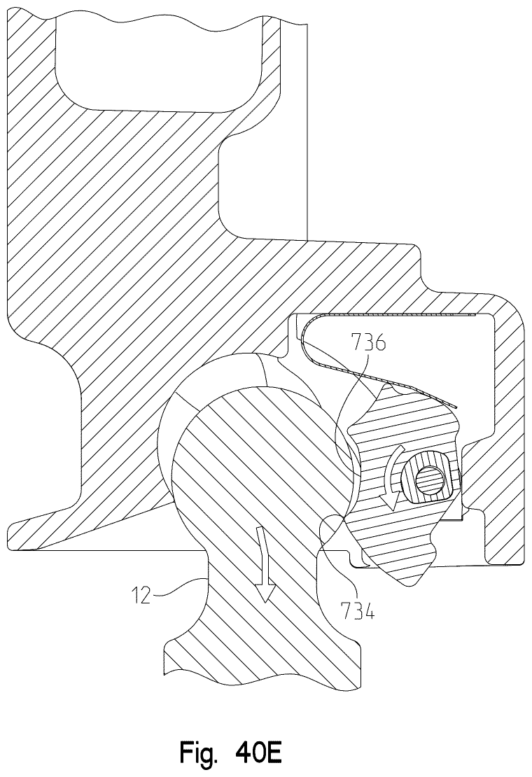

A different self-resetting embodiment of the coupler 710 is shown in FIGS. 37-40E. The coupler 710 shown can receive, couple to, and release the hitch ball 12. As shown, the coupler 710 includes other features for a gooseneck application, but the same mechanism can be used with bumper pull or other ball-and-socket applications. The coupler 710 has a housing 740 with a fixed ball pocket 720 with a partially spherical inside surface 724. The housing 740 also includes a slot 726 that extends into the fixed ball pocket 720 and a shaft aperture 742. The shaft aperture 742 extends through the slot. The fixed ball pocket 720 has an opening 722 that is offset/shifted from the partially spherical inside surface 724. As can be seen in section views FIGS. 40A-40E, the opening 722 is offset from the fixed ball pocket and shifted towards a lever 730. In other words, the hitch ball 12 must also translate horizontally with respect to the housing 740 once it passes through the opening 722 to fully seat within the fixed ball pocket 720. Adjacent the opening 722 is a funneling surface 728 that is either conical or concave to direct the hitch ball 12 towards the opening 722. The funneling surface 728 does not extend completely around the opening 722. It is interrupted by a lever shroud 746 that flanks the slot 726 and protrudes below the funneling surface 728. The lever shroud 746 protects the lever 730 from being damaged by a misaligned hitch ball during coupling.

The lever 730 is located in the slot 726 and is attached to a shaft 760. The lever 730 includes a cam surface 732, a reset portion 734, a ball clearance cove portion 736, and a ball engagement surface 738. A keyed aperture 731 extends through the thickness of the lever and can receive a keyed end 764 on the shaft 760 to lock the lever 730 and shaft 760 together for rotation about a shaft axis 762. The cam surface 732 is a curved/convex surface that has a center point that is offset from the shaft axis 762. As will be described in greater detail below, the reset portion 734 is a protrusion that can contact the hitch ball 12 to reset the coupler. Located between the ball engagement surface 738 and reset portion 734 is the ball clearance cove portion 736 that is closer to the shaft axis 762 than the reset portion 734 and ball engagement surface 738. The ball clearance cove portion 736 is concave and has a center point that is spaced from the shaft axis 762 by a first distance. The ball engagement surface 738 is concave and curved to match the outside diameter of the hitch ball 12. The center point of the ball engagement surface is spaced from the shaft axis 762 by a second distance which is less than the first distance. A hold point 737 is located at the upper edge of the ball engagement surface 738. The lever 730 also includes a release limit surface 733 and latch limit surface 735 that limit rotation of the lever by contacting a limit surface 744 in the housing.

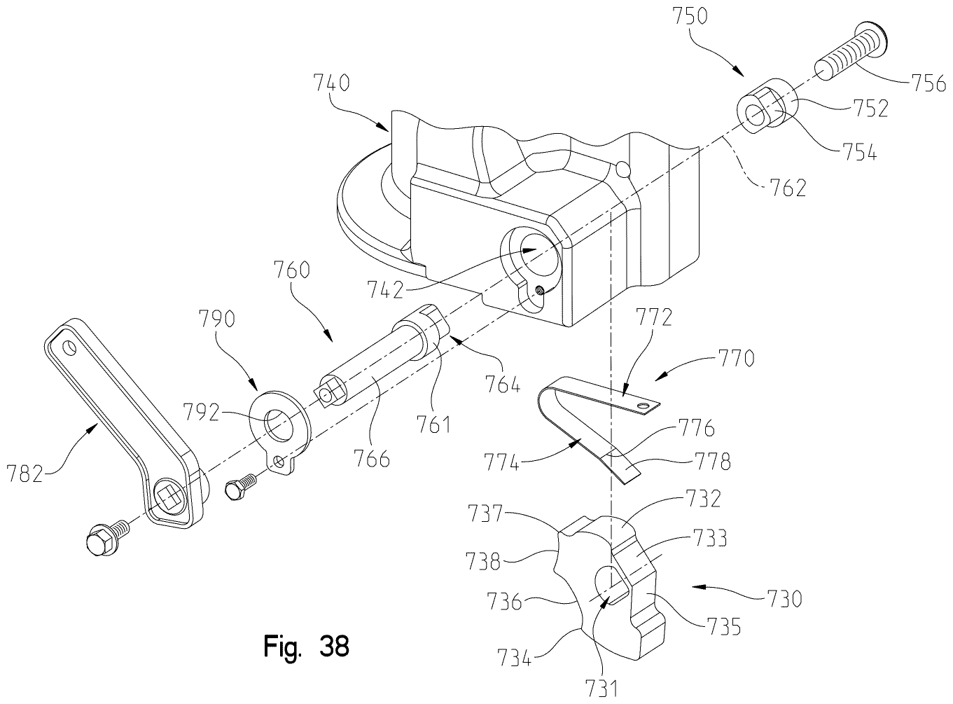

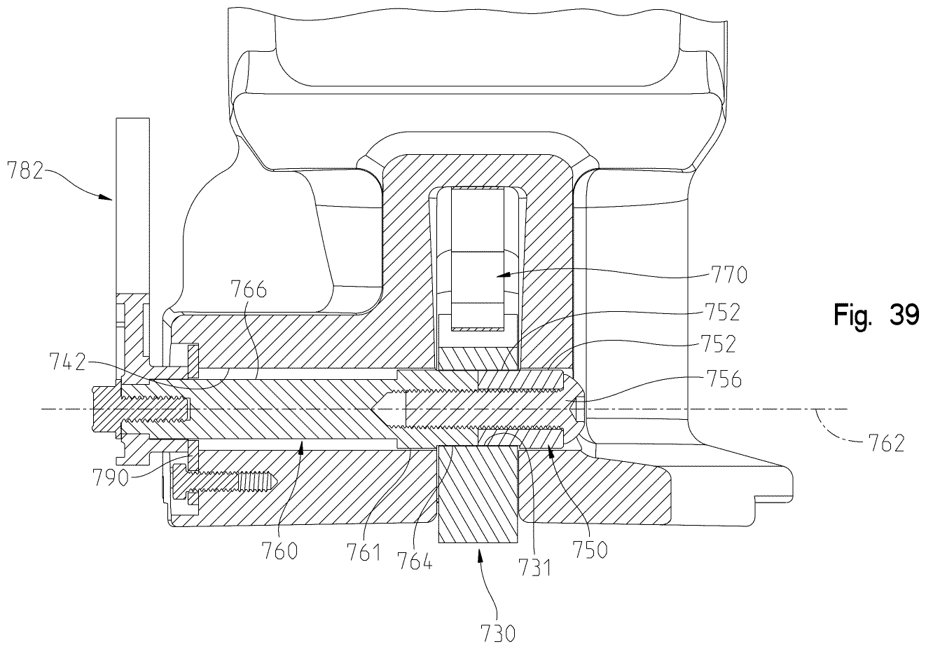

The shaft 760 also has a bearing diameter 761 and a minor diameter 766 that allows the lever to rotate. At the end of the minor diameter 766 is a square that allows the shaft 760 to mate with a release handle 782. A keyed bushing 750 has a bearing diameter 752 and a keyed portion 754 that is also received by the keyed aperture 731. As can be seen in FIGS. 38-39, a fastener 756 secures the keyed bushing 750, lever 730 and shaft 760. The shaft aperture 742 and bearing diameters 752, 761 allow the assembly to rotate. The minor diameter 766 is supported by a pin guide 790 that has a central aperture 792. As can be seen in FIG. 39, the pin guide 790 is secured to the housing 740 with a fastener.

A spring 770, as shown in the FIGS, is formed from flat material into a “U” shape. A fixed portion 772 is in contact with an inside surface of the notch, and a moving portion 774 is connected to the fixed portion. The moving portion includes a bend 776 and a cam follower portion 778.

The operation of the coupler 710 will now be described. As can be seen in FIGS. 40A-E, the features on the lever 730 have interactions and relationships with other components, such as the hitch ball 12, housing 740, and spring 770. The lever 730 is rotatable between a latched position (shown in FIGS. 40A and 40C) and a released position (shown in FIG. 40D). The lever 730 rotates about the shaft axis 762 roughly 45 degrees between the latched and released position. The spring 770 remains in biased contact with the lever 730 throughout its rotation between the released position and latched position. In addition, the lever 730 has a counterweight portion 739 that protrudes beyond the lever shroud 746. The counterweight portion 739 is located opposite the cam surface 732. FIG. 40A shows the lever 730 in the latched position and latch limit surface 735 contacting limit surface 744. The hitch ball 12 has just started to enter the fixed ball pocket 720 where it is contacting the lever 730 and started to displace it from the latched position. As the hitch ball 12 continues towards the fixed ball pocket 720, the lever 730 continues to rotate away from the latched position by the hitch ball 12 to the position shown in FIG. 40B. In the positions shown in FIGS. 40A and 40B, the hitch ball 12 is adjacent to or located in the ball clearance cove portion 736. As can be seen in FIGS. 40A and 40B, the cam follower portion 778 remains in biased contact with the cam surface 732, urging the lever towards the latched position. FIG. 40B represents the maximum rotation of the lever 730 as displaced by the hitch ball 12, which is short of the released position. As the hitch ball 12 continues into the fixed ball pocket 720 (just before it contacts the inside surface 724), the lever 730 is clear enough of the hitch ball 12 to return to the latched position. This is shown in FIG. 40C, with the ball engagement surface 738 in biased contact with the outside spherical surface of the hitch ball. Any forces between the coupler 710 and hitch ball 12 only allow rotation between the two parts but not disengagement. To release the hitch ball 12 from the coupler 710, the user rotates the release handle 782, which in turn rotates the lever 730 to the released position shown in FIG. 40D. In the released position, the hold point 737 contacts the spring 770, lifting the cam follower portion 778 off of the cam surface 732. In this released position, the lever 730 will remain in this angular position unless acted upon by another object, such as the release handle 782 or hitch ball 12. As can be seen in FIG. 40D, the ball clearance cove portion 736 faces the hitch ball 12 but the hitch ball cannot escape the fixed ball pocket 720 without contacting a portion of the lever 730. This is shown in FIG. 40E, where the distance between the opening 722 and the reset portion 734 is less than the outside diameter of the hitch ball 12. As the hitch ball 12 continues to move away from the fixed ball pocket 720, it contacts the reset portion 734, moving the lever 730 away from the released position. Once the lever 730 is moved away from the released position, the cam follower portion 778 contacts the cam surface 732, where the lever 730 is biased towards the latched position. As the hitch ball 12 continues to move away from the fixed ball pocket, the hitch ball 12 remains adjacent to the ball clearance cove portion and the lever returns to the latched position as shown in FIG. 40A.

It is understood that while certain aspects of the disclosed subject matter have been shown and described, the disclosed subject matter is not limited thereto and encompasses various other embodiments and aspects. No specific limitation with respect to the specific embodiments disclosed herein is intended or should be inferred. Modifications may be made to the disclosed subject matter as set forth in the following claims.

What is claimed is:

1. A self-latching ball coupler for connecting to a hitch ball having a diameter, said ball coupler comprising:
a housing having a fixed ball pocket with an opening, said housing having a slot adjoining and extending into said fixed ball pocket;
a lever located in said slot, said lever having a ball engagement surface, a reset portion, and a ball clearance cove portion located between said ball engagement surface and said reset portion;
a shaft fixed with respect to said lever, said shaft and said lever rotatable with respect to said housing between a latched position and a released position, in said latched position, said ball engagement surface faces said fixed ball pocket, in said released position, said ball clearance cove portion faces said fixed ball pocket;
a release handle fixed with respect to said shaft and rotatable therewith;
a spring in biased contact with said lever, when said lever is in said released position, said spring retains said lever in said released position, when said lever is moved away from said released position, said spring urges said lever towards said latched position;
said hitch ball is removable from said fixed ball pocket when said lever is in said released position;
when said hitch ball is in said fixed ball pocket and said lever is in said released position, when said hitch ball is removed, said hitch ball contacts said reset portion and moves said lever away from said released position.

2. The ball coupler of claim 1, wherein said housing has a limit surface facing said lever, said lever having a release limit surface adjacent a latch limit surface, said latch limit surface is obliquely angled with respect to said release limit surface.

3. The ball coupler of claim 1, said spring having a fixed portion in biased contact with said housing and a moving portion connected to said fixed portion, said moving portion having a follower portion, said lever having a cam surface, said follower portion spaced from said cam surface when said lever is in said released position, said follower portion is in biased contact with said cam surface when said lever is moved away from said released position.

4. The ball coupler of claim 3, wherein said spring is formed from a strip of flat material, said follower portion is obliquely angled with respect to said moving portion.

5. The ball coupler of claim 1, wherein said housing having a lever shroud portion flanking said slot and extending beyond said opening in a direction opposite said fixed ball pocket.

6. A self-latching ball coupler for coupling and releasing a hitch ball having a diameter, said ball coupler comprising:
a housing having a fixed ball pocket complementary to said diameter, said fixed ball pocket having an opening, said housing having a slot adjoining and extending into said fixed ball pocket, said housing having a lever shroud portion flanking said slot and extending beyond said opening in a direction opposite said fixed ball pocket;
a lever located in said slot and rotatable about a shaft axis between a latched position and a released position, said lever having a concave ball engagement surface spaced from said shaft axis by a first distance, said concave ball engagement surface extending to a concave ball clearance cove surface spaced from said shaft axis by a second distance, said concave ball clearance cove surface terminating at a reset portion, in said latched position, said concave ball engagement surface faces said fixed ball pocket, in said released position, said concave ball clearance cove surface faces said fixed ball pocket;
a release handle fixed with respect to said lever and rotatable therewith;
a spring in biased contact with said lever, when said lever is in said released position, only said spring retains said lever in said released position, when said lever is moved away from said released position, said spring urges said lever towards said latched position;
said hitch ball is removable from said fixed ball pocket when said lever is in said released position;
when said lever is in said released position, said reset portion extends into said opening to narrow said opening smaller than said diameter; and
when said hitch ball is removed from said fixed ball pocket, said hitch ball contacts said reset portion and moves said lever away from said released position.

7. The ball coupler of claim 6, said spring having a fixed portion in biased contact with said housing and a moving portion connected to said fixed portion, said moving portion having a follower portion, said lever having a cam surface, said follower portion spaced from said cam surface when said lever is in said released position, said follower portion is in biased contact with said cam surface when said lever is moved away from said released position.

8. The ball coupler of claim 7, when said lever is in said latched position and said hitch ball is moved into said fixed ball pocket, said lever remains in biased contact with said hitch ball and said follower portion remains in contact with said cam surface.

9. The ball coupler of claim 7, wherein said spring is formed from a strip of flat material, said follower portion is obliquely angled with respect to said moving portion.

10. The ball coupler of claim 6, wherein said first distance is greater than said second distance.

11. The ball coupler of claim 6, wherein said lever has a latch limit surface and a release limit surface, when said lever is in said released position, said release limit surface is adjacent said housing, when said lever is in said latched position, said latch limit surface is adjacent said housing.

12. The ball coupler of claim 6, wherein said lever protrudes beyond said lever shroud portion.

13. The ball coupler of claim 6, wherein removing said hitch ball from said fixed ball pocket resets said lever to said latched position.

14. A self-latching ball coupler for connecting to a hitch ball having a diameter, said ball coupler comprising:
a housing having a fixed ball pocket with an opening, said housing having a slot adjoining and extending into said fixed ball pocket;
a lever located in said slot and rotatable about a shaft axis between a latched position and a released position, said lever having a first concave surface extending to a second concave surface, said second concave surface terminating at a reset portion, said lever having a convex surface spaced from said first and second concave surfaces, in said latched position, said first concave surface faces said fixed ball pocket, in said released position, said second concave surface faces said fixed ball pocket;
a release handle fixed with respect to said lever and rotatable therewith about said shaft axis;
a spring in biased contact with said lever, when said lever is in said released position, said spring retains said lever in said released position, when said lever is moved away from said released position, said spring contacts said convex surface to urge said lever towards said latched position; and
when said hitch ball is in said fixed ball pocket and said lever is in said released position, said reset portion partially extends into said opening to narrow said opening and when said hitch ball is removed, said hitch ball contacts said reset portion and moves said lever away from said released position.

15. The ball coupler of claim 14, when said hitch ball passes through said opening and into said fixed ball pocket, said lever approaches but does not reach said released position.

16. The ball coupler of claim 14, wherein removal of said hitch ball from said ball coupler resets said lever to said latched position.

17. The ball coupler of claim 14, said spring having a fixed portion in biased contact with said housing and a moving portion connected to said fixed portion, said moving portion having a follower portion, said follower portion spaced from said convex surface when said lever is in said released position, said follower portion is in biased contact with said convex surface when said lever is moved away from said released position.

18. The ball coupler of claim 17, when said lever is in said latched position and said hitch ball is moved into said fixed ball pocket, said lever remains in biased contact with said hitch ball and said follower portion remains in contact with said convex surface.

19. The ball coupler of claim 17, wherein said spring is formed from a strip of flat material, said follower portion is obliquely angled with respect to said moving portion.

20. The ball coupler of claim 14, said housing having a lever shroud portion flanking said slot and extending beyond said opening in a direction opposite said fixed ball pocket.
